(19) United States
(12) Patent Application Publication
(10) Pub. No.: US 2015/0157036 A1
(43) Pub. Date: Jun. 11, 2015

(54) Processed Cheese With Natural Antibacterial And Antimycotic Components And Method Of Manufacturing

(71) Applicant: KRAFT FOODS GROUP BRANDS LLC, NORTHFIELD, IL (US)

(72) Inventors: Christine D. Marcus-Johnson, Chicago, IL (US); Ammar N. Chinwalla, Gurnee, IL (US); Jon L. Reeve, Glenview, IL (US)

(21) Appl. No.: 14/565,074

(22) Filed: Dec. 9, 2014

Related U.S. Application Data
(60) Provisional application No. 61/914,246, filed on Dec. 10, 2013.

(51) Int. Cl. A23C 19/11; A23C 19/032

(52) U.S. Cl. CPC A23C 19/11; A23C 19/0323; A23Y 2240/41

(57) ABSTRACT

A processed cheese composition and methods of making the processed cheese composition are provided. The processed cheese composition includes natural cheese, dairy materials, as well as natural antibacterial and natural antimycotic components. In one aspect, the natural antibacterial component comprises raisin and the antimycotic component comprises natamycin. The combination of the natural antibacterial and natural antimycotic components provides significantly longer shelf life even at low concentrations of the natural antibacterial and natural antimycotic components.

### CROSS-REFERENCE TO RELATED APPLICATION

This application claims the benefit of U.S. Provisional Application No. 61/914,246, filed Dec. 10, 2013, which is incorporated herein by reference in its entirety.

### SEQUENCE LISTING

The instant application contains a Sequence Listing which was submitted as a text file via EFS-Web and is hereby incorporated by reference in its entirety. The text file was created on Dec. 10, 2013 and is named “131820 Sequence Listing_ST25” and is 46,229 bytes in size.

### FIELD

The present application generally relates to processed cheese compositions and methods for manufacture, and more particularly, processed cheese compositions containing natural antibacterial and antimycotic components.

### BACKGROUND

Processed cheese, widely available in sliced and loaf forms, has become one of the more popular selling cheese products. Processed cheese products are particularly popular with children. Processed cheese is conventionally prepared by heating, grinding and/or mixing one or more varieties of milk-fat containing natural cheeses, such as, for example, Cheddar cheese, Colby cheese, Swiss cheese, Brick cheese, Muenster cheese, pasta filata cheese, washed curd, and granular curd cheese to suggest but a few types. The resulting cheese is then blended with other dairy products, such as non-fat dry milk and whey solids, and emulsifying salts, such as disodium phosphate, at temperatures which are sufficiently elevated to pasteurize the cheese and to produce a homogeneous, pumpable, fluid cheese material that may be formed into sheets, slices, or other desired forms.

It is often desirable to prolong the shelf life of food, such as processed cheese, and/or increase microbiological stability of such food. By increasing the amount of time a food is stable, processors can mitigate inventory losses due to spoiled foodstuffs. Prior methods, such as the use of packaging, preservatives, and/or specific storage parameters (e.g., refrigeration), have been used to stave off spoilage.

In particular, Listeria monocytogenes and C. botulinum can, in some instances, be a concern with foods like as raw milk, cheeses (particularly soft-ripened varieties), ice cream, raw vegetables, fermented raw meat sausages, raw and cooked poultry, raw meats (of all types), and raw and smoked fish. The ability of these pathogens to grow, in some instances, at temperatures as low as 3° C. permits multiplication in refrigerated foods.

Furthermore, while it is desired to provide improved shelf life to foods, such as processed cheese, there also has been an increased desire to provide foods that contain an increased amount of natural ingredients. In this regard, it may be desirable to provide foods which include only natural ingredients or otherwise remove artificial materials. For example, processed cheese oftentimes utilizes preservatives such as sorbic acid to improve food safety and shelf life. It may be desirable to incorporate natural preservatives and/or antimicrobials while maintaining and/or improving the characteristics of the processed cheese.

### SUMMARY

Provided herein are processed cheeses including natural antibacterial and antimycotic components. In one approach, the natural antibacterial is nisin. In some approaches, the nisin includes nisin A. In another approach, the natural antimycotic is natamycin. It has been unexpectedly found that a processed cheese including nisin and natamycin has a remarkably long shelf-life due to inhibition of growth of mold and Gram-positive microorganisms despite inclusion of low amounts of the nisin and natamycin. It is particularly surprising that these low amounts of nisin and natamycin are effective to prolong the shelf life of the processed cheese products because natamycin is known to be prone to degradation.

In some approaches, the processed cheese is free of artificial preservatives selected from the group consisting of sorbic acid, potassium sorbate, nitrites, and combinations thereof. As used herein, the phrases “does not contain,” “is free of” or “substantially free of” mean less than about 0.5 percent, in other approaches, less than about 0.1 percent and, in some cases, less than about 0.05 percent and in other cases, none.

In some approaches, the processed cheese includes an amount of natural antibacterial effective to prevent toxin formation from Clostridium botulinum for at least about 9 days when the processed cheese is stored at about 86° F. The processed cheese also includes natural antibacterial in an amount effective to prevent more than 1 log of growth of Listeria monocytogenes for at least about one month, in another aspect at least about two months, in another aspect at least about three months, in another aspect at least about four months, in another aspect at least about five months, in another aspect at least about six months, and in yet another aspect at least about 7 months, during storage at 45° F. In some aspects, the nisin is nisin A.

The amount of natamycin added during the manufacture of the processed cheese should be selected keeping in mind that a portion of the natamycin will be degraded during the cooking process. Therefore, the amount of natamycin initially added to the processed cheese may be significantly higher than that remaining in the product at, for example, one month, two months, or three months of storage. Generally, it is desirable to select process conditions that optimize the retention of natamycin in the product. It was also found to be desirable to select an initial natamycin concentration that is effective to provide a processed cheese product that, after the cooking step in the process for producing the processed cheese, has retained about 0.1 to about 15 ppm natamycin, in other approaches about 0.5 to about 10 ppm natamycin, in other approaches about 0.5 to about 8 ppm natamycin, in other approaches about 0.5 to about 6 ppm natamycin, in other approaches about 2 to about 6 ppm natamycin, in other approaches about 2 to about 5 ppm natamycin, and in other approaches about 2 to about 4 ppm natamycin, as detected by HPLC. In one aspect, the amount of natamycin may be measured within 72 hours of completion of the cooking step, such as within 72 hours of packaging of the product. As this is the amount remaining after the cooking step, it may be necessary that a larger quantity of natamycin be included initially such that the described quantities remain after at least a portion of the natamycin is degraded during production of the processed cheese.

In some approaches, the processed cheese includes an amount of natural antimycotic effective to prevent mold growth for at least about three months, in another aspect at least about four months, in another aspect at least about five months, in another aspect at least about six months, and in yet another aspect at least about seven months, when the processed cheese is stored at about 1 to about 10° C. The efficacy of the natamycin in the processed cheese product can be determined by conducting a mold challenge study, where samples of the processed cheese are inoculated with a known quantity of mold spores, such as 90 cfu/g or 500 cfu/g, and inspecting the samples for visible mold growth during storage at 40 to 45° F.

In some approaches, the nisin of the processed cheese may be included in the processed cheese in the form of a cultured dairy component, which may be provided in about 1 to about 20 percent in the processed cheese. The nisin in the cultured dairy component may also be obtained from a fermentation of a single bacterial strain in a liquid dairy medium. The bacterial strain may be any nisin-producing bacterial strains, such as nisin-producing strains of Lactococcus lactis. A preferred Lactococcus lactis strain for use herein has all of the identifying characteristics of the Lactococcus lactis strain of ATCC PTA-120552.

In one aspect of this approach, the processed cheese includes about 10 to about 90 percent natural cheese or a mixture of natural cheeses; one or more optional emulsifiers; about 8 to about 25 percent protein; and about 10 to about 30 percent fat.

A method is also provided for producing a processed cheese including natural antibacterial and antimycotic components. The method includes fermenting a liquid dairy medium with a Lactococcus lactis strain to produce a cultured dairy component including nisin and adding natamycin and the cultured dairy component to a natural cheese or mixture of natural cheeses with one or more emulsifiers to produce a processed cheese having about 8 to about 25 percent protein and about 10 to about 20 percent fat. The processed cheese includes about 0.5 to about 6 ppm natamycin and an amount of nisin effective to prevent toxin formation from C. botulinum determined by toxin bioassay with mice in the processed cheese at the protein and the fat levels thereof for about 9 days at 86° F.

The method may include the fermentation of the Lactococcus lactis strain ATCC PTA-120552 conducted in a 2× to a 5× concentrated liquid dairy medium at a temperature of about 25 to about 35° C. and a pH of about 5 to about 6 for about 15 to about 48 hours. In some approaches, the concentrated liquid dairy medium is a concentrated milk having a total solids of about 5 to about 36 percent, about 1 to about 14 percent protein, and about 0 to about 16 percent fat.

In other approaches, the method is effective so that the processed cheese is free of artificial preservatives selected from the group consisting of sorbic acid, potassium sorbate, nitrites, and mixtures thereof.

In some approaches, the cultured dairy component of the method includes nisin A and a bacterial strain having at least one gene from a nisin producing gene cluster with significant homology to the sequences selected from the group consisting of SEQ ID NOS 9 to 19.

### BRIEF DESCRIPTION OF THE DRAWINGS

FIG. 1 is a process flow diagram illustrating production of an exemplary cultured dairy component produced from a concentrated dairy liquid;

FIG. 1A is an alternative process flow diagram;

FIG. 2 is a process flow diagram illustrating a second form of production of an exemplary cultured dairy component produced from powdered dairy ingredients;

FIG. 3 is a table showing the results of a mold challenge study of processed cheese including nisin and natamycin;

FIG. 4 is a chart showing the results of phage typing analysis of nisin-producing strains;

FIG. 5 includes results of Riboprinter analysis of various Lactococcus lactis strains;

FIG. 6 is a chart comparing the EPS-related genes of various lactic acid bacteria; and

FIG. 7 shows the amino acid sequence of nisin A.

### DETAILED DESCRIPTION

The present application is generally directed to processed cheese including, among other aspects, natural antibacterial and antimycotic components. The processed cheese provided herein including both natural antibacterial (such as nisin) and antimycotic (such as a polyene compound such as natamycin) has significantly improved antimicrobial properties as compared to processed cheese with the same formulation except artificial preservatives and/or other types of prior natural antimicrobials. It was unexpectedly discovered that the combination of natural antibacterial and antimycotic components in the processed cheese described herein was effective inhibit Gram-positive microorganisms such as C. botulinum and mold growth at remarkably low levels of both components. In one aspect, the natural antibacterial and natural antimycotic components are incorporated into the processed cheese during production of the cheese and not included as a topical application.

As discussed more below, prior antimicrobials tended to be less effective in the context of a processed cheese with high levels of protein and fat because it was believed that the levels of protein and fat in processed cheese in combination with lower moisture levels provided a cheese matrix that tended to protect and/or shield various pathogens from being inhibited by commercial forms of nisin and other natural antimicrobials. It has been unexpectedly found that a processed cheese including nisin and natamycin has a remarkably long shelf-life due to inhibition of growth of mold and Gram-positive microorganisms despite inclusion of low amounts of the nisin and natamycin. It is particularly surprising that these low amounts of nisin and natamycin are effective to prolong the shelf life of the processed cheese products because natamycin is known to be prone to degradation.

As used herein, the terms “natural antibacterial” and “natural antimycotic” refer to components with antibacterial and antimycotic activities, respectively, which are produced by an organism, such as by a bacterial culture during a fermentation process. One or more different natural antibacterial and antimycotic components may be included in the processed cheese. In one form, the processed cheese contains a sufficient amount of natural antibacterial and antimycotic components such that the processed cheese does not contain or is free of artificial preservatives, such as sorbic acid, potassium sorbate and the like. As used herein, the phrases “does not contain,” “is free of” or “substantially free of” mean less than about 0.5 percent, in other approaches, less than about 0.1 percent and, in some cases, less than about 0.05 percent and in other cases, none.

In some approaches, the processed cheese includes an amount of natural antibacterial effective to prevent toxin formation from Clostridium botulinum for at least about 9 days when the processed cheese is stored at about 86° F. The processed cheese also includes natural antibacterial in an amount effective to prevent more than 1 log of growth of Listeria monocytogenes for at least about one month, in another aspect at least about two months, in another aspect at least about three months, in another aspect at least about four months, in another aspect at least about five months, in another aspect at least about six months, and in yet another aspect at least about seven months, during storage at about 45° F.

Preferred natural antimycotics include polyene antimycotics, such as natamycin, and preferred natural antibacterials include, for example, nisin. In one approach, the processed cheeses herein include about 0.1 to about 100 ppm natural antibacterial, in other approaches about 0.1 to about 20 ppm natural antibacterial, in other approaches about 1 to about 15 ppm natural antibacterial, in other approaches about 1 to about 10 ppm of natural antibacterial, in other approaches about 1 to about 5 ppm of natural antibacterial, in other approaches about 3 to about 5 ppm of natural antibacterial, and in yet other approaches about 3 to about 4 ppm of natural antibacterial. In some approaches, the processed cheeses herein include about 0.1 to about 100 ppm nisin, in other approaches about 0.1 to about 20 ppm nisin, in other approaches about 1 to about 15 ppm nisin, in other approaches about 1 to about 10 ppm of nisin, in other approaches about 1 to about 5 ppm of nisin, in other approaches about 3 to about 5 ppm of nisin, and in yet other approaches about 3 to about 4 ppm of nisin. In yet other approaches, the nisin includes nisin A.

In another aspect, the processed cheeses described herein include about 0.1 to about 15 ppm natural antimycotic, in other approaches about 0.5 to about 10 ppm of natural antimycotic, in other approaches about 0.5 to about 8 ppm of natural antimycotic, in other approaches about 0.5 to about 6 ppm natural antimycotic, in other approaches about 2 to about 4 ppm natural antimycotic, and in yet other approaches about 2 to about 4 ppm natural antimycotic. In some aspects, the natural antimycotic is natamycin.

The amount of natamycin added during the manufacture of the processed cheese should be selected keeping in mind that a portion of the natamycin will be degraded during the cooking process. Therefore, the amount of natamycin initially added to the processed cheese may be significantly higher than that remaining in the product at, for example, one month, two months, or three months of storage. Generally, it is desirable to select process conditions that optimize the retention of natamycin in the product. It was also found to be desirable to select an initial natamycin concentration that is effective to provide a processed cheese product that, after the cooking step in the process for producing the processed cheese, has retained about 0.1 to about 15 ppm natamycin, in other approaches about 0.5 to about 10 ppm natamycin, in other approaches about 0.5 to about 8 ppm natamycin, in other approaches about 0.5 to about 6 ppm natamycin, in other approaches about 2 to about 6 ppm natamycin, in other approaches about 2 to about 5 ppm natamycin, and in other approaches about 2 to about 4 ppm natamycin, as detected by HPLC. In one aspect, the amount of natamycin may be measured within 72 hours of completion of the cooking step, such as within 72 hours of packaging of the product. As this is the amount remaining after the cooking step, it may be necessary that a larger quantity of natamycin be included initially such that the described quantities remain after at least a portion of the natamycin is degraded during production of the processed cheese.

In some approaches, the processed cheese includes an amount of natural antimycotic effective to prevent mold growth for at least about three months, in another aspect at least about four months, in another aspect at least about five months, in another aspect at least about six months, and in yet another aspect at least about seven months, when the processed cheese is stored at about 1 to about 10° C. The efficacy of the natamycin in the processed cheese product can be determined by conducting a mold challenge study, where samples of the processed cheese are inoculated with a known quantity of mold spores, such as 90 cfu/g or 500 cfu/g, and inspecting the samples for visible mold growth during storage at 40 to 45° F.

In one form, the natural antimycotic comprises natamycin, also known as pimaricin. Natamycin can be produced by fermentation using Streptomyces natalensis or other organism that has been genetically modified to produce natamycin. Commercially available sources of natamycin can be used, if desired, such as NATAMAX™ SF (87% powdered natamycin) from Danisco. Other natural antifungal agents such as, for example, polylysine (produced by certain Streptomyces species) may also be included, if desired.

In one form, the natural antibacterial component is incorporated into the processed cheese via cultured dairy components or concentrated cultured dairy components, which include a natural antibacterial component and/or a culture capable of producing a natural antimicrobial under appropriate fermentation conditions. As used herein, the terms “cultured dairy component” or “concentrated cultured dairy component” generally refer to cultured milk substrates or derivatives thereof that have undergone, in some approaches, concentration and fermentation with selected antimicrobial-producing cultures under conditions effective to produce antibacterial peptides, such as raisin, unless specifically identified as not including cultured antibacterial components.

The natural antibacterial component can be produced by fermentation using an antibacterial-producing strain of lactic acid bacteria. As used herein, the term “lactic acid bacteria” generally refers to gram-positive bacteria that generate lactic acid as a major metabolite of carbohydrate fermentation. The lactic acid bacteria may be, for example, an antibacterial producing strain of Lactococcus lactis or, in alternative approaches, Brevibacterium linens.

In some aspects, the natural antibacterial component is an antibacterial peptide. For example, the antibacterial peptide may comprise nisin and, in some approaches, nisin A. Nisin is an inhibitory polycyclic peptide with 34 amino acid residues. It contains the uncommon amino acids lanthionine, methyllanthionine, dehydroalanine and dehydro-amino-butyric acid. These amino acids are synthesized by posttranslational modifications. In these reactions a ribosomally synthesized 57-mer is converted to the final peptide. The unsaturated amino acids originate from serine and threonine.

Nisin can be obtained by culturing nisin-producing bacteria on natural substrates, including milk. Nisin has been included in food products to extend the safe, usable life by suppressing gram-positive spoilage and pathogenic bacteria. Due to its highly selective activity, it may also be employed as a selective agent in microbiological media for the isolation of gram-negative bacteria, yeast and molds. Two commercially available antimicrobials containing nisin are Nisaplin® and Novasin™ (both from Daniso A/S, Denmark). Typically, Nisaplin contains less than about 3.0 weight % nisin, the remainder consisting of NaCl, proteins, carbohydrates and moisture. When referring to a nisin component herein the component may include not only nisin, but also other ingredients, such as carriers, salts, protein, carbohydrates, and metabolites that result from the fermentation process.

In one aspect, the antibacterial component includes nisin A. Nisin A has a molecular weight of about 3,351.5 Da and the amino acid sequence of SEQ ID NO 1. It should be understood that other natural antimicrobials may also be utilized in the processed cheese products described herein. For example, other forms of nisin, including Nisin Z, Nisin Q, Nisin F, and Nisin F, may be included. Other bacteriocins may also be included, such as class I bacteriocins, class II bacteriocins, class III bacteriocins, and class IV bacteriocins.

Further, bacterial strains that produce natural antimicrobials may be provided. Such bacterial strains include, for example, antibacterial-producing strains of lactic acid bacteria, such as for example, nisin-producing strains of Lactococcus lactis or Brevibacterium linens.

### Processed Cheese

In one approach, the processed cheese may be produced by blending together natural cheese or mixture of natural cheeses, moisture (e.g., in the form of water or ultra-filtered milk), and an optional additional dairy protein source (such as milk protein concentrate, whey, whey protein concentrate, ultra-filtered milk, and the like). The natural antimycotic, such as natamycin, can also be added at this time. Sodium chloride may be added for flavor. Other optional ingredients may be added to improve texture, flavor, nutrition, and/or cost attributes. These include, but are not limited to, whey derived ingredients (e.g., whey protein concentrate), non-fat dry milk, milk protein concentrate, anhydrous milk fat, gums, starches, gelatin, and the like. The ingredients are blended together and transferred to a cooker (e.g., a laydown cooker) and heated to pasteurization temperatures. In some aspects, the nisin, which in some approaches is in the form of a cultured dairy component, is added to the cooker. It may be desirable to add the nisin to the cooker, and not prior to the cooking step, because the nisin could be at least partially consumed, thereby decreasing its efficacy during storage, by any microorganism present after the blending step. Optionally, shear may be applied during or after the heating to form a substantially homogenous mass. The product is then packaged in suitable or desired forms, such as slice or loaf form.

Moisture may be added to the blend by any method, such as, but not limited to, injecting steam into the cooker, comingling of condensed steam from cooking, and/or direct addition of water. Of course, moisture can also enter into the system through the various ingredients (e.g., moisture from the natural cheese). Overall moisture of the final cheese products includes all moisture independent of how the moisture was introduced into the final product. Advantageously, because the cultured dairy component includes nisin, water management of the processed cheese is improved. To this end, because nisin and other texture modifying ingredients do not need to be separately added, less water tends to be added into the processed cheese via the cultured dairy component ingredient.

Whey protein refers to a collection of globular proteins that can be isolated from whey, which is the liquid remaining after milk has been curdled and strained. Whey protein is typically a mixture of beta-lactoglobulin, alpha-lactalbumin, and serum albumin proteins. In one embodiment, whey protein concentrate (WPC) may be used as the whey protein source. WPC is derived from whey by conventional concentration techniques. The whey protein source may also include lactose, vitamins, minerals, and fat.

As is known by one of ordinary skill in the art, the ingredients may be used in varying amounts in the processed cheese depending on the desired outcome of the cheese product. For example, for a reduced sodium cheese product, a cheese-maker may include a small amount or no salt in the cheese blend. The processed cheese may also include a range of amounts of the cultured dairy components, depending on the form and composition of the cultured dairy components and the desired form of the processed cheese.

For example and in one form, the processed cheese may include about 10 to about 90% natural cheese. According to another form, the processed cheese may include about 30 to about 60% natural cheese. As used herein, natural cheese refers to unpasteurized cheese made by curdling milk or other dairy liquid using some combination of rennet (or rennet substitute) and acidification. The natural cheese used in the processed cheese described herein may be freshly made or aged.

In yet another form, the processed cheeses herein may include about 35 to about 55% natural cheese. As used herein, natural cheese generally means cheese provided from unpasteurized cheese obtained from curdled milk and one of rennet, rennet substitutes, acidification, and combinations thereof.

The processed cheese may also include a number of other dairy ingredients from various sources as needed for a particular application. For example and in one form, the processed cheese may include milk protein concentrate from about 0 to about 50% (in other approaches, about 10 to about 25%), whey protein concentrate from about 0 to about 25% (in other approaches, about 1 to about 10%), whey from about 0 to about 30% (in other approaches, about 1 to about 10%), milkfat/cream from about 0 to about 30% (in other approaches, about 1 to about 15%) and the like. The processed cheese may also include emulsifiers, such as sodium citrate, disodium phosphate and the like in an amount of about 0% to about 5% (in other approaches, about 1 to about 3%). The processed cheese may also include salt, flavorings, fortifications, colorants and the like to provide the desired color, flavor, etc. The processed cheese may also include added water and/or moisture from the ingredients to provide the desired finished product moisture. For example, vitamins and other minerals may also be added as needed to fortify the processed cheese, by one approach, from about 0 to about 3 percent of vitamin A, vitamin D and/or calcium powders (such as tricalcium phosphate). In other applications, salt may also be added as needed. In some approaches, about 0 to about 5 percent salt may be added.

Instead of traditional preservatives, the processed cheese may include natamycin and nisin or a cultured dairy component containing nisin. In one aspect, the cultured dairy component containing nisin may be made via the methods described herein. In one form, the processed cheese may include about 1 to about 20% cultured dairy component. In another form, the processed cheese includes about 4 to about 10% cultured dairy component. In some approaches, the cultured dairy components of the present disclosure provide a much higher total antimicrobial activity as nisin equivalent relative to the nisin content (a nisin activity ratio). For instance and in some approaches, the cultured dairy components and processed cheese utilizing the amounts of cultured dairy components described herein exhibit a nisin activity ratio of about 0.3 or less.

It should be noted that the natural antibacterial and natural antimycotic components may be used as a replacement for artificial preservatives. When the processed cheeses include the cultured dairy components herein, the cheese may be substantially free of traditional preservatives, such as sorbic acid, nitrites and the like. By one approach, substantially free of generally means less than about 0.5 percent, in other approaches, less than about 0.1 percent, and in other approaches, not present at all.

The natural antibacterial and/or natural antimycotic components also may be used to at least partially supplement or replace other components in the overall processed cheese composition. For example, depending on the form of the cultured dairy component, the amount of the cultured dairy component may be used to supplement or otherwise replace a portion of the other dairy materials in the composition, such as the milk fat, casein, whey and the like. In other words, the ratio of the other dairy materials may be modified as a result of the use of the cultured dairy components.

In one form, the processed cheese includes about 40% natural cheese, 35% other dairy materials, about 8% cultured dairy components, about 12% water and the remainder salts, flavoring, colors, vitamins, minerals and the like. The processed cheese may be manufactured as generally understood with the addition of the cultured dairy components during cooking, and alternatively, during cheese blending steps. In one form, the cheese product described herein may be any of a cheese dip, a cheese spread, a cheese block, a cheese slice, a shredded cheese, or the like. In some approaches, the various forms of processed cheese of the present disclosure may include about 10 to about 90% natural cheese, about 0 to about 50% milk protein concentrate, about 0 to about 30% milk fat or cream, about 40 to about 60% water, about 1 to about 20% cultured dairy component, about 0 to about 30% whey, and about 0 to about 25% whey protein concentrate in combination with various optional flavors, salts, and emulsifiers described above.

In another form, the processed cheese includes about 10 to about 30% total fat (in other approaches, about 20 to about 30% fat), about 8 to about 25% total protein (in other approaches, about 15 to about 25% total protein), and about 40 to about 60% total moisture (in other approaches, about 40 to about 50% moisture).

While not wishing to be limited by theory, it is believed that the cheese matrix provided by the high protein, high fat, and, in some cases, the lower moisture level of the processed cheeses described herein tend to protect and/or encapsulate the natamycin so that it better survives the processed cheese cooking step. That such a low amount of natamycin could be included in the processed cheese and still provide significantly long shelf life without development of mold was surprising and unexpected.

While also not wishing to be limited by theory, it presently appears that the cultured dairy component may play a role in the protection of the natamycin during the cook step. It has been noted that processed cheese products prepared with both natamycin and a cultured dairy component provided by the methods described herein alter the quantity of natamycin detectable by HPLC during storage of the product. For instance, the detectable quantity of natamycin was found to increase in months 2 and 3 of storage and then decrease in month 4. It is presently believed that the cheese matrix changes over time during storage, thereby releasing the natamycin in months 2 and 3 so that it can come into contact with and inactivate mold present in the product. The content of natamycin then decreases in the fourth month as the natamycin is consumed by the mold. The increase in detectable content of natamycin during the second and third months was quite surprising as it was instead expected that the natamycin would degrade over time. This effect was not observed when nisin and natamycin were included in other cheese products, such as cream cheese products. Therefore, it is presently believed that the unique protein and fat matrix of the processed cheese product, and possibly that provided when the cultured dairy component described herein is included in the processed cheese product, surprisingly allows for such low quantities of nisin and natamycin to be included while still providing desired microbial and shelf stability.

The processed cheese made with the cultured dairy components of the present disclosure also exhibits improved antimicrobial characteristics in the context of a high protein and high fat product, such as a processed cheese with about 10 to about 30% fat and about 8 to about 25% protein. While prior commercial forms of nisin were commonly understood to inhibit C. botulinum in liquid media or broth, when such prior forms of nisin were used in a high-protein and high-fat food systems, such as processed cheese, the nisin was less effective at inhibiting the C. botulinum and other pathogens. While not wishing to be limited by theory, it is believed that the high protein, high fat, and in some case, the lower moisture level of the processed cheeses described herein, tend to protect and/or encapsulate the C. botulinum and other pathogens rendering traditional nisin and traditional natural antimicrobials less effective. It was unexpectedly discovered that the nisin obtained from the antimicrobial cultures herein, and in particular, strain 329, are effective to inhibit C. botulinum and other food-borne pathogens such as Listeria monocytogenes, in the context of high fat and high protein processed cheese much better than other forms of nisin as generally shown below in Example 1. In some approaches, the cultured dairy component in processed cheese provides an amount of nisin effective to prevent toxin formation from at least C. botulinum as determined by conventional toxin bioassay with mice in the processed cheese at the high protein and the high fat levels described herein for at least about 9 to about 10 days at about 86° F. In one approach, the biotoxin assay may be performed in accordance with Haim M. Solomon et al., Bacteriological Analytical Manual, Chapter 17, Clostridium botulinum, January 2001, available at http://www.fda.gov/Food/FoodScienceResearch/LaboratoryMethods/ucm070879.htm, which is hereby incorporated by reference in its entirety.

Not only are the natamycin and cultured dairy components effective to inhibit mold, C. botulinum and other pathogens in the context of a high protein and high fat processed cheese, the cultured dairy components achieve such inhibitory effects at lower activity levels and/or lower dosage levels than previously found possible.

In other approaches, liquid forms of the cultured dairy components herein or made by the processes described herein retain higher levels of nisin activity in the final processed cheese, which was not achievable using prior commercial forms of nisin when used in processed cheeses. By one approach, the cultured dairy ingredients described herein and made by the methods described herein are effective to retain about 50 to about 90 percent activity, and in other approaches, about 60 to about 75 percent activity as compared to the activity of the ingredient prior to incorporation into the processed cheese.

In some approaches, the cultured dairy component is made using an ultrafiltered dairy liquid either before or after fermentation. In these approaches, the cultured dairy component has reduced levels of lactose and other dairy minerals. For example and in some approaches, the cultured dairy component and the processed cheese utilizing the cultured dairy component may have less than about 0.1 percent lactose and less than about 15 percent lactate as acid. In other approaches, the cultured dairy component and the processed cheese utilizing the cultured dairy component may also have less than about 600 mg/100 grams of calcium.

### Production of Antibacterial Component for Use in Processed Cheese

In one form, a cultured dairy component for inclusion in the processed cheese products described herein includes a dairy substrate fermented with an antimicrobial-producing culture. In some approaches, the dairy substrate is a dairy liquid, such as milk or a concentrated dairy liquid or milk substrate, such as a 2-5X concentrated milk substrate. In one aspect, the antimicrobial-producing culture is a nisin-producing culture. In one particular form, the nisin produced by the culture is nisin A.

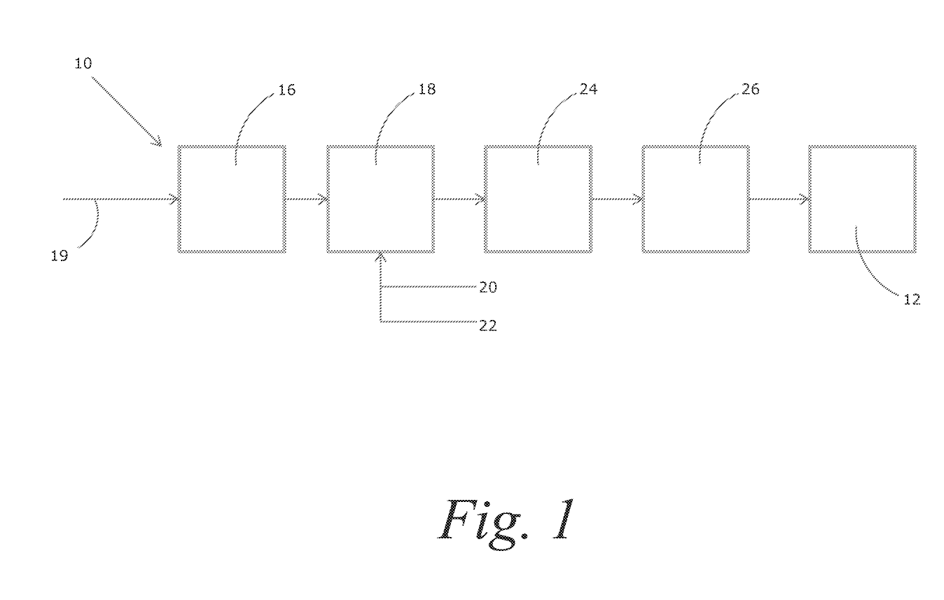

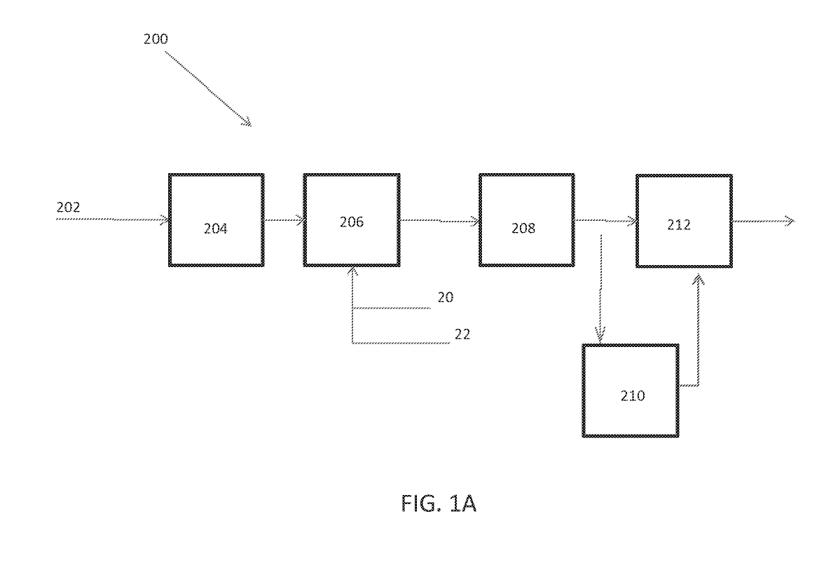

Turning to more of the specifics regarding methods of producing an effective cultured dairy concentrate and processed cheese and first referring to FIG. 1, a process flow diagram 10 is provided that illustrates one method of producing a cultured dairy material or cultured dairy concentrate 12 effective to produce an antibacterial (such as nisin A), the product of which is effective for use with processed cheese. In this exemplary process 10, a liquid dairy starting material 14, such as a dairy liquid like whole milk may be used. In other approaches, the starting dairy liquid may be milk protein concentrate and or whey materials. The starting material 14 may have from about 5 to about 35% total solids, about 0 to about 16 percent fat, about 1 to about 14 percent protein, and about 64 to about 95 percent moisture. In another form, the starting material 14 is 3.5× concentrated whole milk having about 26 to about 30 percent total solids, about 10 to about 15 percent fat, about 8 to about 12 percent protein, and about 70 to about 70 percent moisture.

In another approach, the starting material 14 is a concentrated dairy liquid obtained from the ultrafiltration of liquid dairy milk. The concentrated starting material may be concentrated to a 2× to a 5× concentration as determined by total solids, in other approaches, about a 2× to about a 4×, and in yet other approaches, about a 3× to about a 3.5× dairy liquid. That is, a 3× concentration has 3 times the level of total solids relative to a starting dairy liquid, and a 5× concentration has about 5 times the level of total solids relative to the starting dairy liquid. In one approach, an ultra-filtration membrane may be used to achieve an appropriate concentrated starting material. One suitable membrane has a molecular weight cutoff of about 5 to about 20 KD. Other methods of concentration may also be used including microfiltration, nanofiltration, and reverse osmosis as needed for a particular application.

As discussed further below, fermentation in concentrated milks, such as the 2× to 5× milk of the present disclosure typically presents problems with prior antimicrobial cultures and fermentations. Strain 329 used within the products and methods of the present disclosure uniquely allows fermentation in a concentrated dairy liquid and, at the same time, permits formation of nisin. By utilizing the concentrated milks for the fermentation and the ultimate production of the processed cheese ingredients herein, water content in the resultant process cheese is better controlled. In some approaches, this reduces the overall moisture load in the processed cheese manufacturing process and, in some cases, also simplifies the processed cheese ingredient line.

The starting material 14, which is either a liquid dairy or concentrated liquid dairy component, is then pasteurized 16 and then enters one or more fermenters 18. Pasteurization may be about 150 to about 190° F. for about 20 to about 40 seconds resulting in an exit temperature of the pasteurized starting material of about 80 to about 90° F. An antimicrobial-producing culture 20, such as Lactococcus lactis strain 329, is added to the fermenter 18 along with a base solution 22 such as sodium hydroxide (e.g., a dilute 5.5N sodium hydroxide). In one form, about 2×10⁶ to about 2×10⁸ CFU/ml of the antimicrobial-producing culture 20 is added to the fermenter. In one embodiment, the culture 20 is a thawed form of the culture. In one approach, the fermentation temperature is maintained at about 25 to about 35° C. (in some approaches about 28 to about 32° C., and in other approaches, about 30° C.) and a pH of about 5 to about 6 (in other approaches, about 5.4 to about 5.8, and in yet other approaches, about 5.4 to about 5.6) in the fermenter. Other temperatures and pH's may also be used if the culture is able to produce nisin at a desired level under the selected conditions. For example, in one approach, the pH ranges from about 5 to about 7 and the temperature ranges from about 20 to about 40° C. The composition may be fermented over a variety of different time periods to impart different flavor characteristics to the composition. For example, in one approach, the composition is fermented for about 18 to about 22 hours. In another form, the fermentation may take place over a range of about 15 to about 48 hours.

The composition is next sent to an optional shear device 24 to shear small/soft curds that may have formed. In one approach, the shear device may be a rotor/stator mixer (such as a Dispax) or other rotor shear device. This step may be optional depending on the other processing conditions as well as the properties of the materials utilized in the process. The composition is then finally subjected to an optional heat treatment step 26. In one form, the composition is heat treated 26 at about 150° F. to about 160° F. for approximately about 60 to about 100 seconds. In another form, the composition is heat treated to reduce CFU/ml to less than about 1000 CFU/ml. The resulting composition 12 is a cultured dairy component or cultured dairy concentrate that includes nisin and/or a nisin-producing material. At least in some approaches, these two components are advantageously produced from the same starting bacterial strain, such as strain 329, and under the same fermentation conditions. The composition may be in the form of a liquid having approximately 6 to about 40% total solids. In one form, the liquid has approximately 20 to about 30% total solids, and in some approaches about 28.5% total solids.

In an alternative method 200 shown in FIG. 1A, hydrated powders and/or liquid milk 202 may be first heated 204, such as in a high temperature, short time sterilization (HTST) or an ultra-high temperature (UHT) sterilization process step. Next, the heated liquid is then fermented 206 with similar materials, cultures, and conditions as described with respect to the previously discussed method. After fermentation, the material may be optionally sheared 208 and then concentrated 210. In this approach, concentration may be membrane filtration, evaporation, or centrifugation. After concentration, the resultant concentrate may be optionally heated 212 again using HTST or UHT, for example.

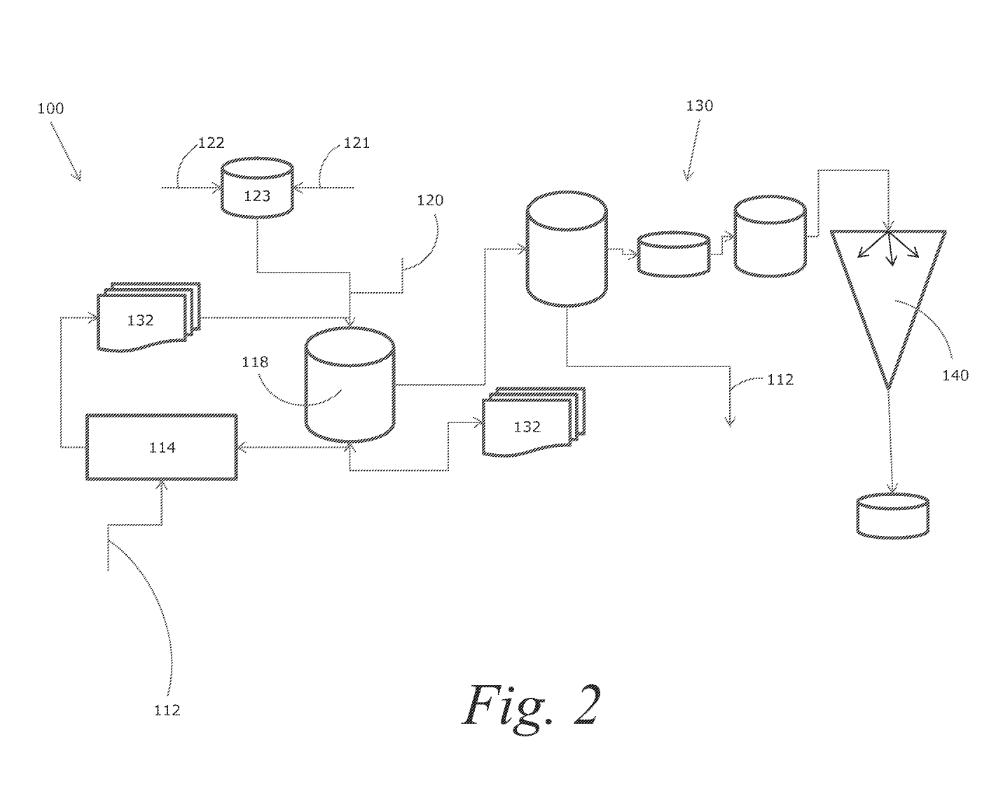

Another process 100 for preparing cultured dairy components is illustrated in FIG. 2. The process 100 in FIG. 2 utilizes powdered starting materials 112 such as powdered milk protein concentrate and powdered whey. In this approach, about 3 to about 10 percent powdered milk protein concentrate, about 2 to about 6 percent powdered whey, and about 75 to about 95 percent water are blended in a tank or a fermenter 118 to form the fermentation medium. The powders may be mixed 114 and hydrated prior to being added to the fermenter 118. These starting materials are then combined with an antimicrobial-producing culture 120, such as Lactococcus lactis strain 329, in an amount of about 2×10⁶ CFU/ml to about 2×10⁸ CFU/ml in the fermentation vessel 118 and fermented in a similar manner as described for FIG. 1. Similar to the method of FIG. 1, process water and a base, such as a dilute sodium hydroxide may also be added to the fermentation vessel 118 from tank 123. After fermentation, the composition may optionally be heated or cooled as necessary and then prepared into a final cultured dairy component 112. In some approaches, the process may include various intermediate heating and cooling 132 as needed for a particular application. In this regard, the composition 112 may be placed in one or more holding tanks 130 or other storage location for use in a concentrated liquid form. Holding tank temperatures may be about 30 to about 50° F. In one embodiment (such as in a liquid form), the cultured dairy component has from about 6 to about 11% total solids and in another form, about 20% total solids. Further, the cultured dairy component may be spray-dried, such as in an atomizer 140. In one approach, the atomizer may have a dryer temperature of about 160 to about 180° F. and about a 15 to about 25 psi pressure drop.

The cultured dairy component may take a variety of forms. For example, as shown in FIGS. 1 and 2, the cultured dairy component may be in the form of a liquid. The cultured dairy component may also take the form of a powder, such as from spray drying as shown in FIG. 2. Furthermore, the cultured dairy component may also be in a concentrated form, such as components obtained by evaporation, filtering and the like. The resulting product of the method from FIG. 1 or 2 may be either a liquid or spray dried depending on the particular application. FIG. 2 provides exemplary steps for spray drying and it will be appreciated that these steps can also be used with the methods of FIG. 1. It will be appreciated that if the cultured dairy component is further processed by concentration, spray drying or the like, this further processing will be completed in a manner to not substantially affect the nisin.

The cultured dairy component produced by the methods of FIGS. 1 and 2 may then be used in and/or to manufacture processed cheese.

As described herein, the term activity unit (“AU”) may be used to describe the biological activity of the natural antimicrobial in the cultured dairy component and processed cheese in which the antimicrobial is incorporated. It should be understood that biological activity may also be expressed in International Units (“IU”) such that AU and IU may be used interchangeably. In some approaches, the cultured dairy components of the present disclosure and the processed cheeses prepared therewith may have nisin activity in the processed cheese of about 40 to about 400 IU/gram and, in other approaches, about 50 to about 200 IU/gram.

In one form, the cultured dairy component comprises a nisin component and/or includes a culture capable of producing a nisin component in the range of about 30 to about 90 ppm by weight of the fermentation medium.

The natural antibacterial can be provided by culturing the antimicrobial-producing bacteria under appropriate fermentation conditions in a dairy substrate. The dairy substrate may include, for example, milk, cream, whey or other dairy-containing powder or liquid. The dairy substrate may also comprise dextrose, corn syrup or other carbohydrates supplemented with other nutrients for bacterial growth, with or without an acid neutralizer such as calcium carbonate.

In some forms, the milk may be in the form of raw milk or a concentrated milk product, such as at least about 2× concentrated milk product, in another aspect up to about 5× concentrated milk product. Typically, the milk base will container greater than about 3 percent lactose and a nitrogen source. The base can be produced from hydrated powders or derived from fresh dairy liquids, such as skim milk, two-percent milk, whole milk, and the like. By one approach, the starting dairy substrate includes concentrated milk having a total solids of about 5 to about 36, a protein content of about 1 to about 14 percent, a fat content of about 0 to about 16 percent, and a moisture content of about 64 to about 95 percent.

When the cultured dairy component is used in production of processed cheese, it has been found to be desirable to maintain a low level of moisture in the dairy substrate to reduce the increased costs associated with removing moisture from the cultured dairy component prior to inclusion in the processed cheese product. Further, certain components of the cultured dairy component may be unstable and may be degraded or otherwise damaged during a moisture removal process. However, the cultured dairy component including cultured antimicrobials may take a variety of forms such as liquid and/or powder, if desired for a particular application.

At least in some approaches, the nisin A-producing culture used herein is Lactococcus lactis ss. lactis strain 329. On Aug. 21, 2013, strain 329 was deposited at the American Type Culture Collection (ATCC), 10801 University Blvd., Manassas, Va. 20110, and given accession number PTA-120552. The deposit was made under the provisions of the Budapest Treaty on the International Recognition of the Deposit of Microorganisms for the Purposes of Patent Procedure. Strain 329 is also described in detail in U.S. patent application Ser. No. 13/973,660, filed Aug. 22, 2013, which is hereby incorporated herein by reference in its entirety.

It has been found that Lactococcus lactis strain 329 has a unique genetic and phage profile compared to other nisin-producing strains of lactic acid bacteria. Advantageously, strain 329 also was found to be able to grow in concentrated dairy substrates, including about a 2× to about a 5× milk. It has been found that few cultures are capable of growing in such highly concentrated milk substrates. For example, the cultures herein are effective to grow to at least about 10⁹ CFU/gram in about 10 hours and produce more than about 2000 IU nisin A/gram in about 18 hours even in the about 2× to about 5× concentrated fermentation medium. Strain 329 was characterized using Multi Locus Sequence Typing (MLST), phage typing, and ribotyping as discussed more below.

Multi Locus Sequence Typing (MLST)

The publicly available genome of L. lactis subsp. Lactis IL 1403 (taxid:272623), also a nisin-producing strain, was used as a template for selection of seven housekeeping genes to be used as genetic markers in a comparison of IL 1403 to strain 329. The selected genes cover a range of loci on the chromosome as detailed in Table 1 below. Each of the seven genes was amplified and sequenced. Sequences were then aligned and compared using IL1403 as the reference. Each sequence variation was accounted for and represents an individual allele.

TABLE 1

| Gene | Protein | Chromosome Location |
|---|---|---|
| acmD | n-acetylmuramidase | 527,413-528,498 |
| (SEQ ID NO 2) | | |
| gapB | Glyceraldehyde 3 phosphate | 2,332,466-2,333,476 |
| (SEQ ID NO 3) | dehydrogenase | |
| pdhD | Lipamidedehydrogenase | 58,971-60,389 |
| (SEQ ID NO 4) | component of pyruvate | |
| | dehydrogenase | |
| pepC | Aminopeptidase C | 1,947,325-1,948,635 |
| (SEQ ID NO 5) | | |
| thiE | Thiamine phosphate | 1,293,610-1,294,257 |
| (SEQ ID NO 6) | pyrophosphorylase | |
| yjjD | ABC transporter permease | 993,341-994,963 |
| (SEQ ID NO 7) | protein | |
| yyaL | GTP binding protein | 11,119-12,234 |
| (SEQ ID NO 8) | | |

Phage Typing

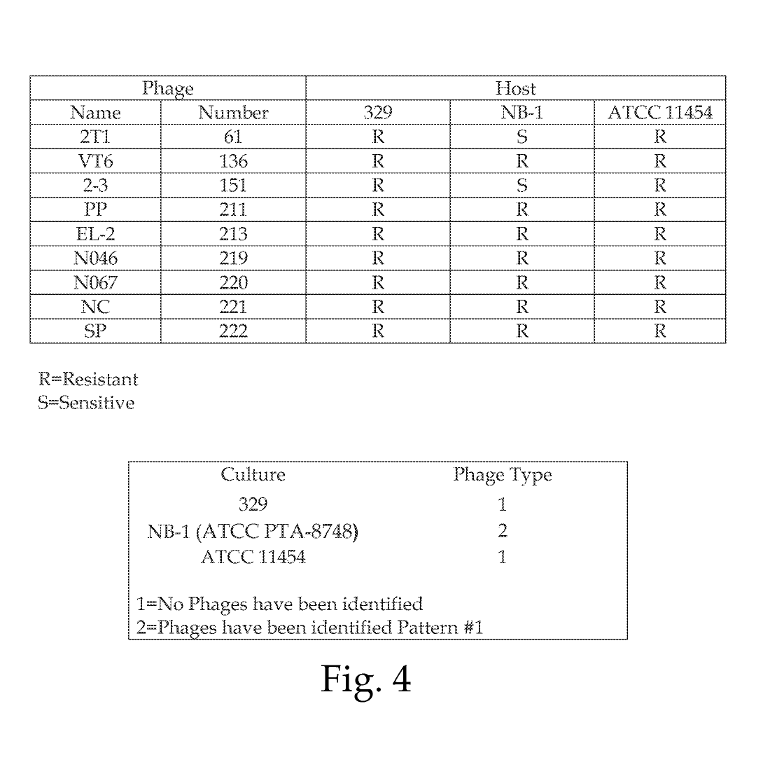

Spot plates were used for phage profiling of high titer phage stocks. The phages are identified and the results of the phage typing are presented in FIG. 4.

Ribotyping

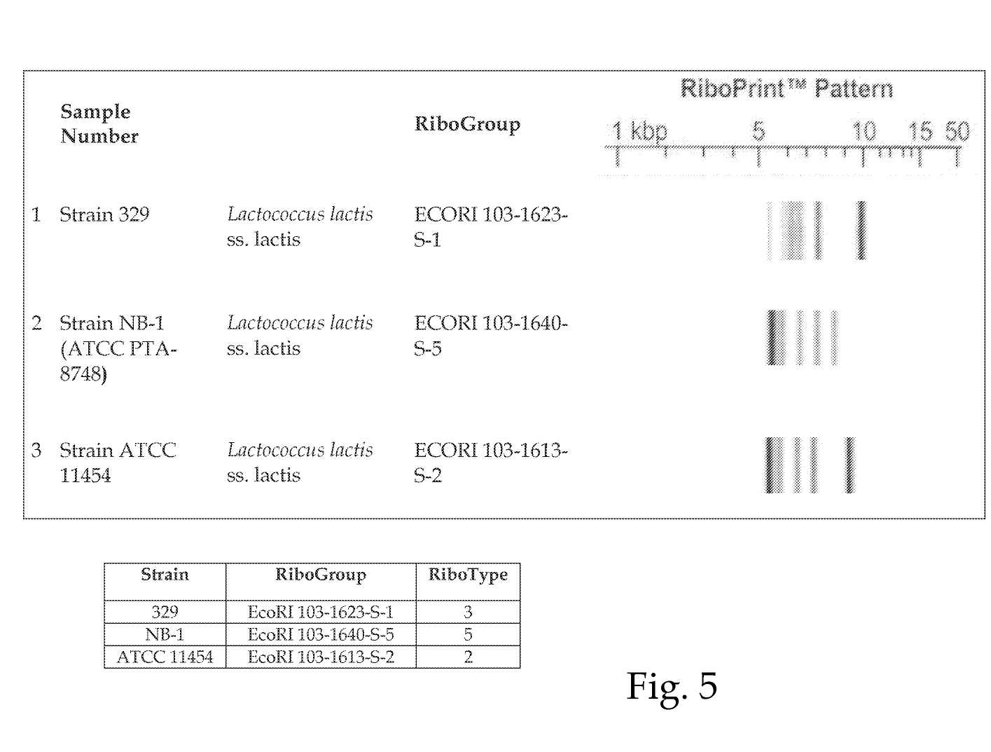

As used herein, “ribotyping” refers to fingerprinting of genomic DNA restriction fragments containing all or part of the genes coding for the 16S and 23S rRNA. Conventional ribotyping techniques utilizing EcoRI as the restriction enzyme were carried out. The results are shown in FIG. 5. Ribotyping confirmed that Lactococcus lactis strain 329 is substantially different from publicly available Lactococcus lactis strain ATCC 11454, also a nisin-producing strain.

DNA Sequence Analysis

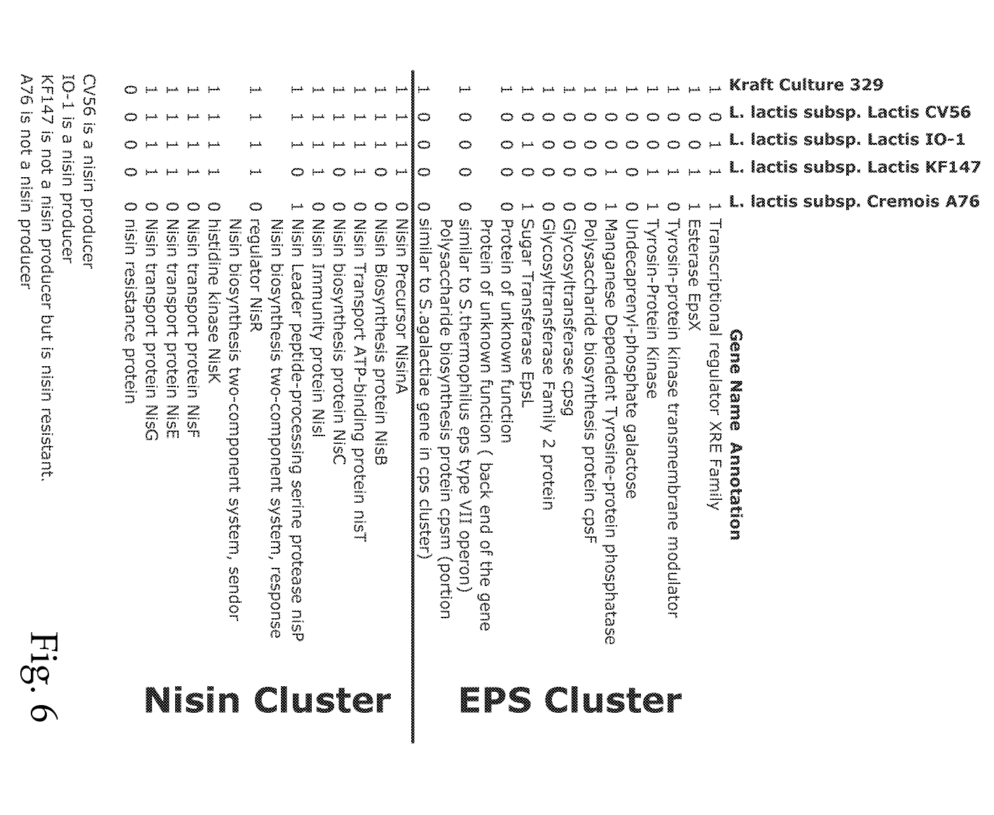

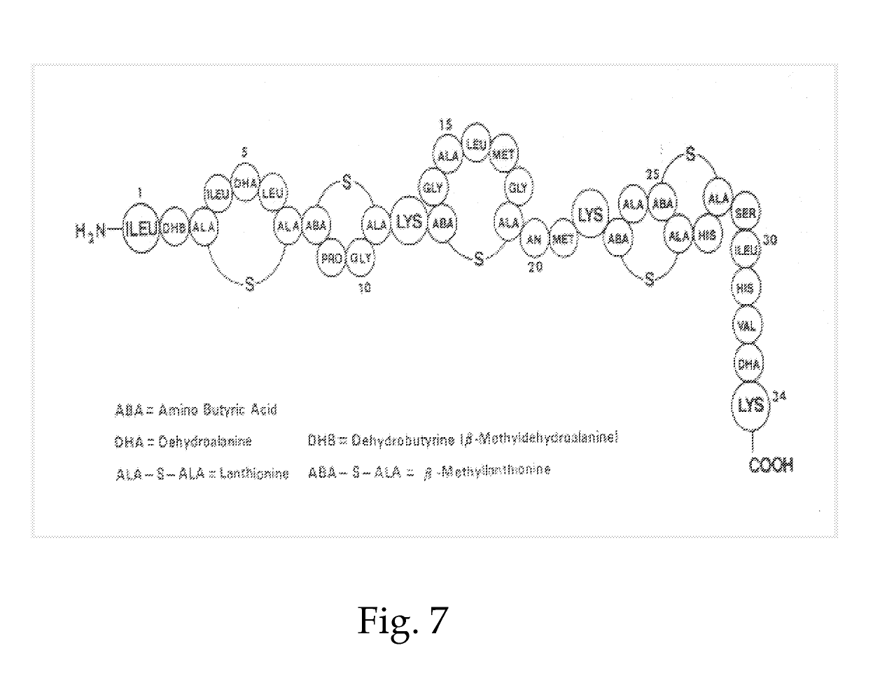

It was found that Lactococcus lactis strain 329 has a unique combination of exopolysaccharide and nisin cluster genes as shown in FIG. 6. Lactococcus lactis strain 329 includes the nisin cluster genes sequence of Table 2 below and produces nisin A having the amino acid sequence of FIG. 7 (SEQ ID NO 1).

TABLE 2

| GENE | SEQ ID Number |
|---|---|
| Nisin precursor nisin A | SEQ ID NO 9 |
| Nisin transport protein (nisG) | SEQ ID NO 10 |
| Nisin transport protein (nisE) | SEQ ID NO 11 |
| Nisin transport protein (nisF) | SEQ ID NO 12 |
| Nisin two-component system, | SEQ ID NO 13 |
| response regulator (nisR) | |
| Nisin sensor-receptor histidine | SEQ ID NO 14 |
| kinase (nisK) | |
| Nisin leader peptide-processing | SEQ ID NO 15 |
| serine protease (nisP) | |
| Nisin immunity protein | SEQ ID NO 16 |
| Nisin biosynthesis protein (nisC) | SEQ ID NO 17 |
| Nisin transport ATP-binding | SEQ ID NO 18 |
| protein (nisT) | |
| Nisin biosynthesis protein (nisB) | SEQ ID NO 19 |

It has been found that, at least under fermentation conditions described herein with reference to the method of FIG. 1, Lactococcus lactis strain 329 produces a high level of 34-mer nisin A relative to the 57-mer nisin A precursor peptide (nisin A precursor has the amino acid sequence of SEQ ID NO 20). Nisin A is produced by posttranslational modification of the nisin A precursor. At least in some approaches, Lactococcus lactis strain 329 produces nisin A relative to nisin A precursor at a ratio of at least about 9:1, in another aspect at least about 9.5:0.5. In contrast, Danisco's Nisaplin® includes approximately 83 percent nisin A and 17 percent nisin A precursor.

Under the same fermentation conditions effective to produce nisin A described above, Lactococcus lactis strain 329 also produces exopolysaccharide, such as, for example, under fermentation conditions described herein with reference to the method of FIG. 1. Lactococcus lactis strain 329 includes the EPS cluster genes of Table 3 below:

TABLE 3

| GENE | SEQ ID Number |
|---|---|
| Transcriptional regulator, XRE | SEQ ID NO 21 |
| family | |
| Esterase (EpsX) | SEQ ID NO 22 |
| Tyrosine-protein kinase | SEQ ID NO 23 |
| transmembrane modulator (epsC) | |
| Tyrosine-protein kinase | SEQ ID NO 24 |
| Undecaprenyl-phosphate galactose | SEQ ID NO 25 |
| phosphotransferase | |
| Manganese depended tyrosine- | SEQ ID NO 26 |
| protein phosphatase | |
| Polysaccharide biosynthesis protein | SEQ ID NO 27 |
| (cpsF)/glycosyl transferase (cpsG) | |
| Glycosyl transferase (cpsG)/ | SEQ ID NO 28 |
| polysaccharide biosynthesis protein | |
| (cpsM(v)) | |
| Glycosyltransferase family 2 protein | SEQ ID NO 29 |
| Sugar transferase, (epsL) | SEQ ID NO 30 |
| Protein of unknown function, | SEQ ID NO 31 |
| unknown family | |
| Protein of unknown function, | SEQ ID NO 32 |
| unknown family/Beta-1,3- | |
| glucosyltransferase | |
| Polysaccharide biosynthesis protein | SEQ ID NO 33 |
| (cpsM(v)) | |

At least in some approaches, an antimicrobial-producing bacterial strain useful in the methods described herein is able to produce both nisin A of about 2000 IU/gram or more and exopolysaccharide under the fermentation conditions described in reference to FIG. 1.

The sequence information provided herein should not be so narrowly construed so as to require inclusion of erroneously identified nucleotides. The sequences disclosed herein can be used by one of ordinary skill in the art to isolate the complete gene from the bacterial strain and subject the gene to further sequence analysis to identify any sequencing errors.

As used herein, the terms “homology” and “identity” are used interchangeably. For purposes of determining the percent identity or homology of two sequences, the sequences may be aligned for optimal comparison purposes. The nucleotides or amino acids are then compared at corresponding nucleotide or amino acid positions of the two sequences. For example, a nucleotide or amino acid in a first sequence is considered identical to that of the second sequence when the same nucleotide or amino acid is located in the corresponding position in the second sequence. The percent identity is calculated by determining the number of identical positions divided by the total number of positions (i.e., overlapping positions) multiplied by 100.

Functional nucleic acid equivalents are also contemplated herein. For example, functional nucleic acid equivalents include silent mutations or other mutations that do not alter the biological function of the encoded polypeptide.

In one form, an antimicrobial-producing bacterial strain useful in the methods described herein has one or more genes of significant homology to SEQ ID NOS 9-19 and 21-33 and is able to produce nisin A. As defined herein, the term “significant homology” means at least 70 percent, in another aspect at least 75 percent, in another aspect at least 80 percent, in another aspect at least 85 percent identity, in another aspect at least 90 percent identity, in another aspect at least 95 percent identity, in yet another aspect at least 99 percent identity, and in yet another aspect complete identity.

In some approaches, an antimicrobial-producing bacterial strain useful in the methods described herein has at least two genes of significant homology to the sequences selected from the group consisting of SEQ ID NOS 9-19 and 21-33, in another aspect has at least three genes of significant homology to the sequences selected from the group consisting of SEQ ID NOS 9-19 and 21-33, in another aspect has at least four genes of significant homology to the sequences selected from the group consisting of SEQ ID NOS 9-19 and 21-33, in another aspect has at least five genes of significant homology to the sequences selected from the group consisting of SEQ ID NOS 9-19 and 21-33, in another aspect has at least six genes of significant homology to the sequences selected from the group consisting of SEQ ID NOS 9-19 and 21-33, in another aspect has at least seven genes of significant homology to the sequences selected from the group consisting of SEQ ID NOS 9-19 and 21-33, in another aspect has at least eight genes of significant homology to the sequences selected from the group consisting of SEQ ID NOS 9-19 and 21-33, in another aspect has at least nine genes of significant homology to the sequences selected from the group consisting of SEQ ID NOS 9-19 and 21-33, in another aspect has at least ten genes of significant homology to the sequences selected from the group consisting of SEQ ID NOS 9-19 and 21-33, in another aspect has at least eleven genes of significant homology to the sequences selected from the group consisting of SEQ ID NOS 9-19 and 21-33, in another aspect has at least twelve genes of significant homology to the sequences selected from the group consisting of SEQ ID NOS 9-19 and 21-33, in another aspect has at least thirteen genes of significant homology to the sequences selected from the group consisting of SEQ ID NOS 9-19 and 21-33, in another aspect has at least fourteen genes of significant homology to the sequences selected from the group consisting of SEQ ID NOS 9-19 and 21-33, in another aspect has at least fifteen genes of significant homology to the sequences selected from the group consisting of SEQ ID NOS 9-19 and 21-33, in another aspect has at least sixteen genes of significant homology to the sequences selected from the group consisting of SEQ ID NOS 9-19 and 21-33, in another aspect has at least seventeen genes of significant homology to the sequences selected from the group consisting of SEQ ID NOS 9-19 and 21-33, in another aspect has at least eighteen genes of significant homology to the sequences selected from the group consisting of SEQ ID NOS 9-19 and 21-33, in another aspect has at least nineteen genes of significant homology to the sequences selected from the group consisting of SEQ ID NOS 9-19 and 21-33, in another aspect has at least twenty genes of significant homology to the sequences selected from the group consisting of SEQ ID NOS 9-19 and 21-33, in another aspect has at least twenty-one genes of significant homology to the sequences selected from the group consisting of SEQ ID NOS 9-19 and 21-33, in another aspect has at least twenty-two genes of significant homology to the sequences selected from the group consisting of SEQ ID NOS 9-19 and 21-33, in another aspect has at least twenty-three genes of significant homology to the sequences selected from the group consisting of SEQ ID NOS 9-19 and 21-33, and in yet another aspect has at least twenty-four genes of significant homology to the sequences selected from the group consisting of SEQ ID NOS 9-19 and 21-33.

Advantages and embodiments of the compositions, methods, and compositions produces by the methods described herein are further illustrated by the following examples; however, the particular conditions, processing schemes, materials, and amounts thereof recited in these examples, as well as other conditions and details, should not be construed to unduly limit this method. All percentages and ratios within this disclosure are by weight unless otherwise indicated.

### EXAMPLES

The following examples illustrate the performance of processed cheese slices prepared with cultured dairy components as described above and control samples of process cheese without the cultured dairy component but, instead, using sorbic acid as the preservative. The samples were generally prepared as processed cheese slices having about 46 percent moisture, about 23 percent fat, about 1.2 percent salt, and about 18 percent protein with varying amounts of preservatives and/or cultured dairy components (where indicated), flavors, colors, vitamins, minerals and the like.

### Example 1

Natamycin (Natamax SF from Danisco) was incorporated into processed cheese (prior to the cooking step) at concentrations of 7 ppm and 15 ppm. The processed cheese was then submitted to a mold challenge study. The processed cheese was inoculated with a mold cocktail (spores in liquid media) of Phoma spp., Geotrichum spp., Cladosporium spp., and Penicillium spp. (which represent common types of mold) at 90 spores per 19 gram slice. The samples are inoculated by spreading the cocktail on top of cheese slices. A control was not inoculated. Processed cheese containing the natamycin significantly extended shelf life by at least six months longer than a control that lacked mold inhibitor. It was surprisingly found that the cheese containing natamycin was effective to extend the shelf life beyond six months when stored at 45° F. even though the detectable natamycin concentration in the product had decreased to 0.62 ppm (for the 7 ppm sample) and 4.89 ppm (for the 15 ppm sample) by six months. The detectable level of natamycin was determined by HPLC.

### Example 2

Natamycin (Natamax SF from Danisco) was incorporated into processed cheese (prior to the cooking step) at concentrations of 0 ppm, 10 ppm, and 15 ppm. Four samples of each dosage were prepared. Cultured dairy component containing nisin was incorporated into all products at 8 percent based on the total weight of the processed cheese. When measured three days after producing the processed cheese, the samples starting with 10 ppm and 15 ppm natamycin had, on average, 2.8 ppm and 4.9 ppm natamycin, respectively.

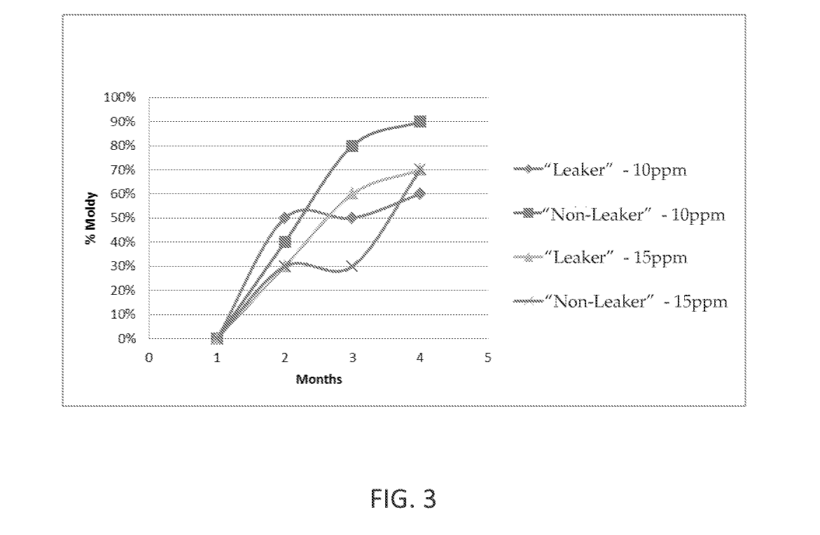

The products were inoculated at 500 cfu/g or 9500 cfu/slice with the mold cocktail of Example 1 by applying the cocktail to the surface of the cheese slices and leaving the packages open. Other packages of the processed cheese (not inoculated with the mold cocktail) were intentionally punctured to provide holes in the package to simulate a real world situation. The results of the 9500 spores per slice inoculation (designated “non-leaker”) and punctured package experiments (designated “leaker”) are shown in FIG. 3. These samples exhibited shelf life of almost double that of control when inoculated with 500 cfu/g or 9,500 spores per slice of processed cheese, even with the extremely large 9,500 spores/slice inoculation level.

### Example 3

Processed cheese slices were produced containing about 4.8 ppm natamycin (Natamax SF from Danisco). The slices had no visible mold at five months of shelf life when stored at 45° F., whereas a control without natamycin showed visible mold at three months.

### Example 4

Natamycin (Natamax SF from Danisco) was incorporated into processed cheese (prior to the cooking step) at 15 ppm. Cultured dairy component containing nisin was incorporated into all products at 8 percent based on the total weight of the processed cheese. Samples of the processed cheese were inoculated at 100 cfu/g and 500 cfu/g. It was found that the detectable level of natamycin changed during storage of the product at 45° F. as shown in Table 4 below. The detectable level of natamycin was determined by HPLC.

TABLE 4

| | Detected | Detected | Detected | Detected |
|---|---|---|---|---|
| | Natamycin | Natamycin | Natamycin | Natamycin |
| | Concentration | Concentration | Concentration | Concentration |
| Natamycin | (ppm) after | (ppm) after | (ppm) after | (ppm) after |
| Dosage Level | One Week | Two Months | Three Months | Four Months |
| 15 ppm | 4.63 | 6.81 | 6.78 | 3.28 |
| 15 ppm | 4.80 | 5.67 | 7.36 | 3.14 |
| 15 ppm | 4.61 | 6.73 | 6.87 | 3.07 |
| 15 ppm | — | 4.62 | 6.34 | 3.39 |
| 15 ppm | — | 6.32 | 7.46 | 3.64 |
| 15 ppm | — | 5.34 | 6.13 | 2.97 |
| 15 ppm | — | 5.91 | 6.84 | 3.37 |
| | Average = 4.68 | Average = 5.93 | Average = 6.77 | Average = 3.39 |

At approximately three months, the detectable natamycin level appears to peak to an average of 6.8, which is advantageous from a commercial perspective as processed cheese product may remain available in stores at three months.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A processed cheese including natural antibacterial and antimycotic components, the processed cheese comprising:
about 10 to about 90 percent natural cheese or a mixture of natural cheeses;
one or more emulsifiers;
about 8 to about 25 percent protein;
about 10 to about 30 percent fat;
an amount of nisin effective to prevent toxin formation from C. botulinum determined by toxin bioassay with mice in the processed cheese at the protein and the fat levels thereof for about 9 days at 86° F.; and
about 0.5 to about 6 ppm natamycin.

2. The processed cheese of claim 1, wherein the processed cheese includes about 2 to about 6 ppm natamycin.

3. The processed cheese of claim 1, wherein the processed cheese includes about 2 to about 5 ppm natamycin.

4. The processed cheese of claim 1, wherein the nisin is included in the processed cheese in the form of a cultured dairy component.

5. The processed cheese of claim 1, wherein the processed cheese includes about 1 to about 100 ppm nisin.

6. The processed cheese of claim 1, wherein the processed cheese includes about 1 to about 20 percent of the cultured dairy component.

7. The processed cheese of claim 4, wherein the cultured dairy component is provided by fermentation of an isolated Lactococcus lactis strain having all of the identifying characteristics of the Lactococcus lactis strain of ATCC PTA-120552.

8. The processed cheese of claim 7, wherein the fermentation of the bacterial strain ATCC PTA-120552 is conducted in a 3× to a 5× concentrated liquid dairy medium at a temperature of about 25 to about 35° C. and a pH of about 5 to about 6 for about 15 to about 48 hours.

9. The processed cheese of claim 1, wherein the processed cheese is free of artificial preservatives selected from the group consisting of sorbic acid, potassium sorbate, nitrites, and mixtures thereof.

10. The processed cheese of claim 1, wherein the nisin is nisin A.

11. A method of producing a processed cheese including natural antibacterial and antimycotic components, the method comprising:
fermenting a liquid dairy medium with a Lactococcus lactis strain to produce a cultured dairy component including nisin;
adding natamycin and the cultured dairy component to a natural cheese or mixture of natural cheeses with one or more emulsifiers to produce a processed cheese having about 8 to about 25 percent protein and about 10 to about 20 percent fat;
wherein the processed cheese includes about 0.5 to about 6 ppm natamycin and an amount of nisin effective to prevent toxin formation from C. botulinum determined by toxin bioassay with mice in the processed cheese at the protein and the fat levels thereof for about 9 days at 86° F.

12. The method of claim 11, wherein the processed cheese includes about 2 to about 6 ppm natamycin.

13. The method of claim 11, wherein the processed cheese includes about 2 to about 5 ppm natamycin.

14. The method of claim 11, wherein the processed cheese includes about 1 to about 100 ppm nisin.

15. The method of claim 11, wherein the cultured dairy component includes about 1 to about 100 ppm of nisin.

16. The method of claim 11, wherein the processed cheese includes about 1 to about 20 percent of the cultured dairy component.

17. The method of claim 11, wherein the processed cheese is free of artificial preservatives selected from the group consisting of sorbic acid, potassium sorbate, nitrites, and mixtures thereof.

18. The method of claim 11, wherein the nisin is nisin A.


SEQUENCE LISTING (33 sequences)

SEQ ID NO: 1 - protein, 34 aa, Lactococcus lactis
  MISC_FEATURE (2)..(2): Dehydrobutyrine (beta-methyldehydroalanine)
IXAIXLAXPGAKXGALMGANMKXAXAHASIHVXK

SEQ ID NO: 2 - DNA, 1086 bp, Lactococcus lactis
atgaaacagaaacataaattagcgcttggtgcgtcaattgttgctttggcaagtcttggtgggattaaagcacaagctgcatctgttcaagaaattattaacgctgcggtaccagtggcaaatgactacggactttatccatcagtaatgattgcccaagggattttagaatcaagtggtggacaaagtgccttagcaagcaattataataatatttttggagttaaatacacttctggtacacctgtttatctaccaacacaagagtatttgaatggaacaatgacaaatgttgttgaacccttccaagcttatagctcagtttatgacgcatgtgttgcccaagctaaaatgttacgtgcttcatcatattattctggggcttggcgtgaaaatacaagttcttacttagatgcgacagcttggcttgaaggacgttatgccacggatccaacttatgcttctaaattgaatagcgtgatttctgaacttggtttaagtgtttatgaccaaggaggagaaatatcaggaggaactgctgttacaactagttcatcagcctcaacaaattcagctggcacatacaaagtacaagagggtgattcattatcagcaatcgctgctcaatatggtacaactgttgatgcacttgtgtcagcaaatagtttagaaaatgcgaacgatattcatgtaggagaagttttgcaagttgctggtgctagcacaactacaacaagtaccaatacaacttccaatgtatcgtcaagttctacttataccgtcaaatcaggagatagtttatattcgattgcggaacaatatggaatgactgtttcatcactgatgtcagccaatggaatttatgatgttaattcaatgcttcaagtaggacaagtattgcaagtaactgtaagtactagtgcaacaacttcaaacacaacgacttcaaacagttatacaattcaaaatggtgacagcatttattcaattgccacagcaaatggtatgacagctgaccaattagcagccctcaatggatttggaattaatgacatgattcatccaggacaaacaattagaatctaa

SEQ ID NO: 3 - DNA, 1011 bp, Lactococcus lactis
atggtagttaaagttggtattaacggtttcggtcgtatcggtcgtcttgctttccgtcgtattcaaaatgttgaaggtgttgaagttgttgcaatcaacgacttgacagatccagcaatgcttgctcacttgcttaaatacgatacaactcaaggtcgttttgatggtaaagttgaagttaaagatggtggttttgaagttaacggtaaattcgttaaagttactgctgaatctaacccagctaacatcaactgggctgaagttggtgcagaaatcgttcttgaagcaactggtttcttcgcaactaaagaaaaagctgaacaacacttgcacgctaacggtgctaaaaaagttgttatcactgcacctggtggatctgatgttaaaacaatcgttttcaacactaaccacgaagtacttgatggaactgaaacagtaatttcagctggttcatgtacaactaactgtcttgctccaatggctgatactttgaacaaacaattcggtatcaaagttggtacaatgactacagttcacggttacactggtgaccaaatgactcttgatggcccacaccgtggtggagacttccgtcgcgcacgtgctgcagctgaaaacatcgtacctaactcaacaggtgctgctaaagctatcggtcttgtattgccagaacttcaaggtaaacttcaaggacatgctcaacgtgtaccagttccaactggttcattgactgaacttgttactatccttaacaaagaagttacagttgacgaaatcaacgcagctatgaaagctgcttcaaatgaatcatttggttacaacgaagaccaaatcgtttcatctgatatcgttggtatctcaaactcttcactctttgatgctactcaaactgaagttacttcagctgatggagctcaacttgttaaaactgtatcttggtacgataacgaaatgtcatacacttcaaaccttgttcgtacacttgcatacttcgctaaaatcgctaaataa

SEQ ID NO: 4 - DNA, 1419 bp, Lactococcus lactis
atggttgttggtgcacaagcaacagaagttgatttggttgttattggttcaggccctggtggttatgttgcagccatccgtgcggctgaacttggtaaaaaagttacaattattgaaaaagataatgttggtggggtttgtttaaatattggttgtatcccatcaaaagcattgattaatattggtcatcattaccaagaatctttggaggaagaaaaaggagaaaatccttttggtctttctgtcggaaatgttaaattaaactgggaatctgcccaaaaatggaaacaagataaagttgtcaaccagttgacaggtggtgttaaaatgctacttaaaaaacacaaagttgacgtgattcaaggaactgcagaatttattgataacaatacaataaatgttgaacaagaagatgggttccaacttttgcaatttaatgatgtgattatctcaactggttcacgtcctatcgaaattccttctttcccatttggtggtcgcattattgactctactggtgctttgtcacttccagaagttcctaaacatttgattattgttgggggaggagttattggttctgagcttggtggagcataccgtatgctcggttctaagattacaattgttgaaggtttggaccacattttaaacgggtttgataaagaaatgtctgatatcattgctaatcgcgttaaatctgctggttctgaaatctttacttcagcaatggctaaatcagctactcaaactgataaagatgtaactttgacttttgaggttgacggaaaagaacaaacggtgactggtgattacttactcgtttctgttggacgtcgtccaaatactgatttaatcggcttgaacaacactgatgttaaattgactgaccgtggtttgattgaagttgacgattcttatgcaactaatgttcctcacatttatgcaatcggtgatgtggttcctggtccaatgctcgctcacaaagcttctttccaagctaaagttgctgctgctgcgattgctggagctgaggacgacgtggacttacacgttgctttgcctgctgtagcttatacaacaactgaattagcaacagttggagaaacgcctgaatcagttaaagaccgtaaagatgttaaaatttctaagttcccatttgctgcaaatggccgtgccatttcaatgaatgatacgactggtttcttacgtttgattactgaaactaaagaaggggccttaatcggtgctcaaatcgttggccctggtgcatctgacttgatttctggtttatcactagcgattgaaaatggattgacttctaaagacatttcattgactatccaacctcacccaacacttggtgaagcgattatggatacagctgaattggctgatggcttaccaattcacgtttaa

SEQ ID NO: 5 - DNA, 1311 bp, Lactococcus lactis
atgacagtaacatcagatttcacacaaaaactctacgaaaattttgcagaaaatacaaaattgcgtgcggtggaaaatgccgtgactaaaaatggtttgctttcatcactcgaagtccgtggttcacatgcagcaaatttgcctgagttttcaattgacttgacaaaagaccctgtaacgaatcaaaaacaatctggtcgttgctggatgtttgctgctttgaacactttccgtcataaatttatcaatgaatttaaaacagaggattttgagttttcacaagcttacactttcttctgggataaatatgaaaaatcaaactggttcatggaacaaattattggtgatattgaaatggacgatcgtcgtttgaaattccttttacaaacaccacaacaagatggcggccaatgggatatgatggttgcaatttttgaaaaatatggaattgttcccaaagctgtttatcctgaatcacaagcttcaagtagctcacgtgaattgaatcaatacttgaataaactactccgtcaagatgctgaaattttgcgttatacaattgagcaaggtggagatgttgaagcagttaaagaagaacttttgcaagaagtctttaatttccttgcggtaactttaggtttgccaccacaaaattttgaatttgctttccgtaataaagataatgaatacaaaaaatttgttggtagtccaaaagaattttacaatgaatatgttggaattgatttgaataattatgtgtcagtaatcaatgctccaactgctgacaaaccttataataagagctacacagttgagtttcttggaaatgttgtcggtggtaaagaagtgaaacatttgaatgttgaaatggaccgctttaaaaaattggccattgcccaaatgcaagctggtgaaacagtttggtttggttgtgacgtgggtcaagaatcaaatcgttcagcaggacttttgacaatggattcttatgatttcaaatcttcattggatattgaatttactcaaagcaaagcaggacgtcttgactatggtgagtcgttgatgacgcatgccatggttttagcgggtgttgatttagatgctgacggaaattcaactaaatggaaagttgaaaattcatggggtaaagatgcgggtcaaaaaggatattttgttgcctctgatgaatggatggatgaatatacttatcaaattgttgtccgtaaagaccttttaactgaagaagaattggctgcttacgaagagaaacctcaagtacttctaccatgggacccaatgggtgctttagcttaa

SEQ ID NO: 6 - DNA, 648 bp, Lactococcus lactis
atgaaaaataaaattttagacctgagggcatattttattgctggcccacaagattttccaaaactttcaattgatgatgcaatcgataaaatttctgtaatcataaaaagtggagtaacggtttatcaatttcgtgataagggaacaatttataaaaataaaaatcaacgattagaagtagcaaaaagactacaagaagtagctcagaaagcggctgtttcttttattgtgaatgatgatgttgaattagcgcgtgaattgtcagctgacgggattcatgtcggacaagacgatgattctgtcagtaaaattcgtgagctgattggccaagaaatgtgggtaggactttctgtcagtaatgatatggaattagaaagcgctcaaaagagtggggctgactatttgggaattggtccaatttatccaacaaatagcaagtccgacgcagcagaaccaattggggttgaccatttaagaaaaatgcttgagcataatcaattaccaactgttggaattggtggaattactgaaaattcactgacagagctttcaaaaattggtctgggtggagttgcggtaatttctttgctgacagaatccgaaaattacaaaaatatggttcaaaaaattaagcaaaatattagatga

SEQ ID NO: 7 - DNA, 1623 bp, Lactococcus lactis
atgaaacaaccactttataatacaggagttttatttaagactttaataaaaagggattggtttaagttagttttctggattttaggaatgcttgcttttgctgcttcaggggcagggaaaatggaagttgcctcgaatccggcgacggctagtactctttatacaatgtttgtcaaaaatccagcaatggtcggattatttggaccaactccaataaataatccaactaattatagtctggggccgatttttggtcaaaccatgactttaattacggggctgactttcgctatcatttcgattatttatgttgttaatcgaagcagaaaagaagaagatgatgggattacagaactttttcggtcttactctattggaaaattggcaaatacgactgctttagtcatggaacttttgctcttaaatttaataatggctgtcttattagctctttcaatagaggtccaaaacgtggctggcttgaatcatttagaaagtaattttctatttgctttcacaacaagcgctcagggtttcctttggggaatgtttgctttacttttcggtcaaattttctctgaagcaagtacaactaaagggatgacatttggtttactgggtttgttatatattgttcgaatgctaacagatgtaacaaatctttccataggttggttcaatcctctgtcttggtcttatctagcttttccatatgttaaaggtcatgaaaattggttagctgtctttttgacttttctcttagcttttctaattttaggaatatcctatattctagagcttaaaagagatgtgggagtggggtattttcccgaaagaaaggcgcgacttcatgggaaaaagggacatttcggatttcctggtctcgttttgaatcttgaaaaaaagatgattatcggttggcttttggcaagttttgttctgggcttagtttatggttcaatgtttggacaaatggaccaatttatttcaagtaataaaaccgttaaggagctttttgttgggaatgaaacggcagcgagtgcgattagaggaaacttcatggtcactctgttttcgatattgtcaatcttaatcgcagcgtttggtgtaattttactgacaaaaatggtgagcgaggaaagaaaaaatcgtctggaagctctttatgctttaccactttcacgactaaaagtgtattccacttatttactgatagctattctgtcagtaattttagctcagtttttagcgctttttggaatatttattgaacagttgggtaataaaaatgctttgagcttcttagaaattatgaaatctggcatgatttggcttgttgctgtcatatttgttttagcaatacttagtctgttacttgggcttgtgcctcgtttggcagaattaatttgggtatatcttgctttcttactttttatgacttatcttggaaaattattatctttgccaaaatggcttgaaaatttaagcatttataactatattcctaaattgccagttgagaaaatgaatcttcctaccgttttattcatattaattttatctgtcttcttagttttacttggctttggagcttatagaagacgcgatttaatcacggggtaa

SEQ ID NO: 8 - DNA, 1116 bp, Lactococcus lactis
atggctttaacagcaggtatcgttggtttaccaaacgttggtaaatcaactctttttaatgcaattacaaaagcaggcgcagaagctgcaaactatccttttgcaacaattgacccaaatgttgggatggtagaagtaccggatgaacgtttaaacaagttaacagagttgattaaacctaagaaaactgttccgacaacttttgaatttacagatattgctgggattgttaaaggggcttcacgcggagaaggtctaggaaataaatttcttgccaatattcgtgaagtagatgccatcattcacgttgttcgagcttttgatgatgaaaatgtaatgcgtgaaaataatcgtgaagatgcttttattgatccaatggcagacattgaaacaattaatcttgaattaattttggccgatttagaatcagtcaataaacgttatgcgcgtgttgaaaaagttgctcgtacggcaaaagataaagatgcggtcgcagaatttaatgttttgaaaaagctcaaaccggtacttgaagatggtaaatcagcacgaacaattgactttgacgaagatgaaataaaggttcttaaaagcttgttcttattgacaagtaaaccagttctttatgtagctaatgtttcagaagatgaagtaggcgaacctgataatatcgaatacgtgaaacaaattcgtgagtttgcggcgactgaaaatgctgaagttgctgtgatttctgctcgtgttgaagaagaaatctcagagttggaagatgatgaaaaagcagaatttttggaagcaattggcttaaaagaatctggtgttgatatgttgactcgtgcagcttaccaccttcttggacttgccacttactttactgctggtgaaaaagaagtccgtgcttggaccttcaagcgtggaatgaaagctccacaaatggcaggaattattcatacagactttgaaaaaggctttatccgcgcagtaactatgtcttatgatgatttgcttaaatacggttcagaaaaagctgttcgtgaagccggtcgcttgcgtgaagaaggaaaagaatatgttggtcaagatggcgacattatggaattccgtttcaacgtgtaa

SEQ ID NO: 9 - DNA, 411 bp, Lactococcus lactis
atggatcgttatactaaaaaagtcattgcttgggatttaggaaagcgaatgactctagaattagtgcaaaggactttgaataaggcaatggaatcacaaaattatccagaagctgtgatgcttcattctgaccaaggaagtcagtatacgagtcatgagtatgaagagacaataaaaaactctggaatgactcactccttcagtcgtaagggctatccttatcataatgccagtcttgaatcttggcatggacatttaaaaagagagtgggtgtatcaatttaaatataagaactttgaagaagcctatcagagtattttctggtacatcgaagccttttataattcaaaacgaatccatcaaagtttagggtatcttacgcctaatcaatttgaaaaagaaatcacttaa

SEQ ID NO: 10 - DNA, 645 bp, Lactococcus lactis
atgataagaagtgaatgtctcaaattaaaaaatagcttagggttttatttagtttttctctttactttattagagcttttaacggttcctatttatttagcttttggaagaagtcatgtttcaatgactgatttatcgctcatgatttttttgttttttccgttactggttacaattttgtctattctaatctttgaacaggagagtctggccaatcgtttccaagaaataaatgtaaataaaaaaagtagcagaatttggttatcaaagctaatagtagtggatttccttttgttctttccatcagcaatgatctggataattacgggagtttcacaggcagtagggcaacaaggaatgatgatcgcaacagctagctggttgatggcaatttttcttaatcattttcatcttttattgacctttataatcaatcgaggagggagcatgattatcgcgattattgaaatattactcattatttttgccagtaataaagttttattagcagcttattggtgtcccattgctttacctgttaattttatgataactgggcggtgtgcttatctgatagctgccgtagggtggattgttttatccacaataattcttgtagcattatctaaaaaaaagattagataa

SEQ ID NO: 11 - DNA, 729 bp, Lactococcus lactis
atgaaaagaataatagcatcagaagcaataaaattaaaaaaatcaggaactcttagattggtattaattatcccttttgtgactctatttatagcatttcttatgggtggaatacagatttttagtgttttttcaatttattggtgggaaactggttttttattccttttgatgagtttgctttttctttatgatataaaatcagaggagcaagctggaaattttcaaaatgtgaaatggaaaaagctgagttggaaaattcatttggccaaaatgttgttgatttggctaagaggtatactagcgagcatagtcttgattattttgctttatttggttgcttttgtgtttcaaggtattgtagtggtggattttatgaaagtaagtgtggcattgattgctatattactagcagcttcttggaatttaccctttatatacttgattttcaagtggattaatacttacgtattgttagctgcgaataccttgatttgtttaattgttgccccttttgttgcacaaactccagtatggttcttgctaccatacacttatcactataaagttacagaaagtttgttaaatatcaaaccatcaggagatttgttaacagggaagataaatttcagtatttgggaagttttattaccatttggactttccatagttgtaacgataggagtttcgtatttacttaaaggagtgatagaacatgataagaagtga

SEQ ID NO: 12 - DNA, 678 bp, Lactococcus lactis
atgcaggtaaaaattcaaaatctttctaaaacatataaagaaaagcaggtgctacaagatatcagttttgatattaaatctggaacagtctgtggtttattaggagttaacggtgcaggaaaatcaactttgatgaaaattttgtttggtttaatttctgcagatactggaaaaattttttttgatggacaagaaaagacaaataatcaacttggagccttaatcgaggctccagcaatatatatgaatttatctgctttcgataatcttaaaactaaggctttgctttttggaatttcagataagagaattcatgaaactctagaagtgattggtttggcagaaacaggaaagaaaagagcaggaaaattctctttagggatgaaacaacgtttgggaattggtatggctattcttacagaacctcaatttttaattcttgatgaacctactaatggtttggatcctgatggtattgcggagttgttaaacttaatcttaaaacttaaagctaaaggtgtgacaatcttgatttctagtcatcagttgcacgaaataagtaaagtagctagtcaaattattattttgaacaaaggtaagattcgttataatcgtgcgaacaataaagaagacgacattgaacagttattctttaagattgtgcatggaggaatgtga

SEQ ID NO: 13 - DNA, 687 bp, Lactococcus lactis
gtgtataaaattttaatagttgatgatgatcaggaaattttaaaattaatgaagacagcattagaaatgagaaactatgaagttgcgacgcatcaaaacatttcacttcccttggatattactgattttcagggatttgatttgattttgttagatatcatgatgtcaaatattgaagggacagaaatttgtaaaaggattcgcagagaaatatcaactccaattatctttgttagtgcgaaagatacagaagaggatattataaacggcttaggtattggtggggatgactatattactaagccttttagccttaaacagttggttgcaaaagtggaagcaaatataaagcgagaggaacgcaataaacatgcagttcatgttttttcagagattcgtagagatttaggaccaattacattttatttagaagaaaggcgagtctgtgtcaatggtcaaacaattccactgacttgtcgtgaatacgatattcttgaattactatcacaacgaacttctaaagtttatacgagagaggatatttatgatgacgtatatgatgaatattctaatgcactttttcggtcaatctcggagtatatttatcagattaggagtaagtttgcaccatacgatattaatccgataaaaacggttcggggacttgggtatcagtggcatgggtaa

SEQ ID NO: 14 - DNA, 1344 bp, Lactococcus lactis
atgggtaaaaaatattcaatgcgtcgacggatatggcaagctgtcattgaaattatcataggtacttgtctacttatcctgttgttactgggcttgactttctttctacgacaaattggacaaatcagtggttcagaaactattcgtttatctttagattcagataatttaactatttctgatatcgaacgtgatatgaaacactacccatatgattatattatttttgacaatgatacaagtaaaattttgggaggacattatgtcaagtcggatgtacctagttttgtagcttcaaaacagtcttcacataatattacagaaggagaaattacttatacttattcaagcaataagcatttttcagttgttttaagacaaaacagtatgcctgaatttacaaatcatacgcttcgttcaatttcttataatcaatttacttaccttttcttttttcttggtgaaataatactcattattttttctgtctatcatctcattagagaattttctaagaattttcaagccgttcaaaagattgcattgaagatgggggaaataactacttttcctgaacaagaggaatcaaaaattattgaatttgatcaggttctgaataacttatattcgaaaagtaaggagttagctttccttattgaagcggagcgtcatgaaaaacatgatttatccttccaggttgctgcactttcacatgatgttaagacacctttaacagtattaaaaggaaatattgaactgctagagatgactgaagtaaatgaacaacaagctgattttattgagtcaatgaaaaatagtttgactgtttttgacaagtattttaacacaatgattagttatacaaaacttttgaatgatgaaaatgattacaaagcgacaatctccctggaggattttttgatagatttatcagttgagttggaagagttgtcaacaacttatcaagtggattatcagctagttaaaaaaacagatttaaccactttttacggaaatacattagctttaagtcgagcacttatcaatatctttgttaatgcctgtcagtatgctaaagagggtgaaaaaatagtcagtttgagtatttatgatgatgaaaaatatctctattttgaaatctggaataatggtcatcctttttctgaacaagcaaaaaaaaatgctggaaaactatttttcacagaagatactggacgtagtgggaaacactatgggattggactatcttttgctcaaggtgtagctttaaaacatcaaggaaacttaattctcagtaatcctcaaaaaggtggggcagaagttatcctaaaaataaaaaagtaa

SEQ ID NO: 15 - DNA, 2010 bp, Lactococcus lactis
ttgggtttatcagcaactgtgcatggggagacaacaaattcacaacagttactctcaaataatattaatacggaattaattaatcataattctaatgcaattttatcttcaacagagggatcaacgactgattcgattaatctaggggcgcagtcacctgcagtaaaatcgacaacaaggactgaattggatgtaactggtgctgctaaaactttattacagacatcagctgttcaaaaagaaatgaaagtttcgttgcaagaaactcaagttagttctgaattcagtaagagagatagcgttacaaataaagaagcagttccagtatctaaggatgagctacttgagcaaagtgaagtagtcgtttcaacatcatcgattcaaaaaaataaaatcctcgataataagaagaaaagagctaacttcgttacttcctctccgcttattaaggaaaaaccatcaaattctaaagatgcatctggtgtaattgataattctgcttctcctctatcttatcgtaaagctaaggaagtggtatctcttagacaacctttaaaaaatcaaaaagtagaggcacaacctctattgataagtaattcttctgaaaagaaagcaagtgtttatacaaattcacatgatttttgggattatcagtgggatatgaaatatgtgacaaataatggagaaagctatgcgctctaccagccctcaaagaaaatttctgttggaattattgattcaggaatcatggaagaacatcctgatttgtcaaatagtttaggaaattattttaaaaatcttgttcctaagggagggtttgataatgaagaacctgatgaaactggaaatccaagtgatattgtcgacaaaatgggacacgggacggaagtcgcaggtcagattacagcaaatggtaatattttaggagtagcaccagggattactgtaaatatatacagagtatttggtgaaaatctttcgaaatcggaatgggtagctagagcaataagaagagctgcggatgatgggaacaaggtcatcaatataagtgctggacagtatcttatgatttcaggatcgtatgatgatggaacaaatgattatcaagagtatcttaattataagtcagcaataaattatgcaacagcaaaaggaagtattgttgtcgcagctcttggtaatgatagtttaaacatacaagataaccaaacaatgataaactttcttaagcgtttcagaagtataaaggttcctggaaaagttgtagatgcaccgagtgtatttgaggatgtaatagccgtaggtggaatagatggttatggtaatatttctgattttagtaatattggagcggatgcaatttatgctcctgctggcacaacggccaattttaaaaaatatgggcaagataaatttgtcagtcagggttattatttgaaagattggctttttacaactactaatactggctggtaccaatatgtttatggcaactcatttgctactcctaaagtatctggggcactggcattagtagttgataaatatggaataaagaatcctaaccaactaaaaaggtttcttctaatgaattctccagaagttaatgggaatagagtattgaatattgttgatttattgaatgggaaaaataaagcttttagcttagatacagataaaggtcaggatgatgctattaaacataaatcgatggagaatcttaaagagtctagggatacaatgaaacaggaacaagataaagaaattcaaagaaatacaaataacaatttttctatcaaaaatgattttcataacatttcaaaagaagtaatttcagttgattataatattaatcaaaaaatggctaataatcgaaattcgagaggtgctgtttctgtacgaagtcaagaaattttacctgttactggagatggagaagattttttaccggctttaggtatagtgtgtatctcaatccttggtatattgaaaagaaagactaaaaattga

SEQ ID NO: 16 - DNA, 738 bp, Lactococcus lactis
atgagaagatatttaatacttattgtggccttaatagggataacaggtttatcagggtgttatcaaacaagtcataaaaaggtgaggtttgacgaaggaagttatactaattttatttatgataataaatcgtatttcgtaactgataaggagattcctcaggagaacgttaacaattccaaagtaaaattttataagctgttgattgttgacatgaaaagtgagaaacttttatcaagtagcaacaaaaatagtgtgactttggtcttaaataatatttatgaggcttctgacaagtcgctatgtatgggtattaacgacagatactataagatacttccagaaagtgataagggggcggtcaaagctttgagattacaaaactttgatgtgacaagcgatatttctgatgataattttgttattgataaaaatgattcacgaaaaattgactatatgggaaatatttacagtatatcggacaccaccgtatctgatgaagaattgggagaatatcaggatgttttagctgaagtacgtgtgtttgattcagttagtggcaaaagtatcccgaggtctgaatgggggagaattgataaggatggttcaaattccaaacagagtaggacggaatgggattatggcgaaatccattctattagaggaaaatctcttactgaagcatttgccgttgagataaatgatgattttaagcttgcaacgaaggtaggaaactag

SEQ ID NO: 17 - DNA, 1245 bp, Lactococcus lactis
atgaataaaaaaaatataaaaagaaatgttgaaaaaattattgctcaatgggatgagagaactagaaaaaataaagaaaacttcgatttcggagagttgactctctctacaggattgcctggtataattttaatgttagcggagttaaaaaataaagataactcaaagatatatcagaaaaagatagacaattatattgaatatattgttagcaaactttcaacatatgggcttttaacaggatcactttattcgggagcagctggcattgcattaagtatcctacatttacgagaagatgacgaaaaatataagaatcttcttgatagcctaaatagatatatcgaatatttcgtcagagaaaaaattgaaggatttaatttggaaaacattactcctcctgattatgacgtgattgaaggtttatctgggatactttcctatctattattaatcaacgacgagcaatatgatgatttgaaaatactcattatcaattttttatcaaatctgactaaagaaaacaatggactaatatcgctttacatcaaatcggagaatcagatgtctcaatcagaaagtgagatgtatccactaggctgtttgaatatgggattagcacatggacttgctggagtgggctgtatcttagcttatgcccacataaaaggatatagtaatgaagcctcgttgtcagctttgcaaaaaattatttttatttatgaaaagtttgaacttgaaaggaaaaaacagtttctatggaaagatggacttgtagcagatgaattaaaaaaagagaaagtaattagggaagcaagtttcattagagatgcatggtgctatggaggtccaggtattagtctgctatacttatacggaggattagcactggataatgactattttgtagataaagcagaaaaaatattagagtcagctatgcaaaggaaacttggtattgattcatatatgatttgccatggctattctggtttaatagaaatttgttctttatttaagcggctattaaatacaaaaaagtttgattcatacatggaagaatttaatgttaatagtgagcaaattcttgaagaatacggagatgaaagtggcacgggttttcttgaaggaataagtggctgtatactggtattatcgaaatttgaatattcaatcaattttacttattggagacaagcacttttactttttgacgattttttgaaaggagggaagaggaaatga

SEQ ID NO: 18 - DNA, 1803 bp, Lactococcus lactis
atggatgaagtgaaagaattcacatcaaaacaattttttaatactttacttactcttccaagcaccttgaagttaatttttcagttggaaaaacgttatgcaatttatttaattgtgctaaatgctatcacagcttttgttccgttggctagtctttttatttatcaagatttaataaactctgtgctaggttcagggagacatcttatcaatattattatcatctattttattgttcaagtgataacaacagttctgggacagctggaaagttatgttagtggaaaatttgatatgcgactttcttacagtatcaatatgcgcctcatgaggactacctcatctcttgaattaagtgattatgagcaggctgatatgtataatatcatagaaaaagttactcaagacagcacttacaagccttttcagctatttaatgctatcattgttgtgctttcatcgtttatctcattgttatctagtctattttttattggaacatggaacattggggtagcaattttactccttattgttccagtattatctttggtactttttctcagagtgggacaattagagtttttaatccagtggcagagagcaagttctgaaagagaaacatggtatattgtatatttattgactcatgatttttcatttaaagaaatcaagttaaataatattagcaattacttcattcataaatttggaaaattaaagaaaggatttatcaaccaagatttagctattgctcgtaagaagacatatttcaatatttttcttgatttcattttgaatttgataaatattcttacgatatttgctatgatcctttcggtaagagcaggaaaacttcttataggtaatttggtaagtctcatacaagctatttctaaaatcaatacttattctcaaacaatgattcaaaatatttacatcatttataatactagtttgtttatggaacaactttttgagtttttaaagagagaaagtgtagttcacaaaaaaatagaagatactgaaatatgcaatcaacatataggaactgttaaagtaattaatttatcatatgtttaccctaattcgaatgcctttgcactaaagaatatcaatttatcctttgaaaaaggagaattaactgctattgtaggaaaaaatggttcagggaaaagtacactagtaaagataatttcaggattatatcaaccaactatgggaataatccaatacgacaaaatgagaagtagtttgatgcctgaggagttttatcagaaaaacatatcggtgctgttccaagattttgtgaagtatgagttaacgataagagagaatataggattgagtgatttgtcttctcaatgggaagatgagaaaattattaaagtactagataatttaggactcgattttttgaaaactaataatcaatatgtacttgatacgcagttaggaaattggtttcaagaagggcatcaactttcaggaggtcagtggcaaaaaattgcattagcaaggacattctttaagaaagcttcaatttatattttagatgaaccaagtgctgcactcgatcctgtagctgaaaaagaaatatttgattattttgttgctctttcggaaaataatatttcaattttcatttctcatagtttgaatgctgccagaaaagcaaataaaatcgtggttatgaaagatggacaggtcgaagatgttggaagtcatgatgtccttctgagaagatgtcaatactatcaagaactttattattcagagcaatatgaggataatgatgaataa

SEQ ID NO: 19 - DNA, 2982 bp, Lactococcus lactis
atgataaaaagttcatttaaagctcaaccgtttttagtaagaaatacaattttatctccaaacgataaacggagttttactgaatatactcaagtcattgagactgtaagtaaaaataaagtttttttggaacagttactactagctaatcctaaactctatgatgttatgcagaaatataatgctggtctgttaaagaagaaaagggttaaaaaattatttgaatctatttacaagtattataagagaagttatttacgatcaactccatttggattatttagtgaaacttcaattggtgttttttcgaaaagttcacagtacaagttaatgggaaagactacaaagggtataagattggatactcagtggttgattcgcctagttcataaaatggaagtagatttctcaaaaaagttatcatttactagaaataatgcaaattataagtttggagatcgagtttttcaagtttataccataaatagtagtgagcttgaagaagtaaatattaaatatacgaatgtttatcaaattatttctgaattttgtgagaatgactatcaaaaatatgaagatatttgtgaaactgtaacgctttgctatggagacgaatatagagaactatcggaacaatatcttggtagtctgatagttaatcattatttgatctctaatttacaaaaagatttgttgtcagatttttcttggaacacttttttgactaaagttgaagcaatagatgaagataaaaaatatataattcctctgaaaaaagttcaaaagtttattcaagaatactcagaaatagaaattggtgaaggtattgagaaactgaaagaaatatatcaggaaatgtcacaaattcttgagaatgataattatattcaaattgatttaattagtgatagtgaaataaattttgatgttaaacaaaagcaacaattagaacatttagctgagtttttaggaaatacgacaaaatctgtaagaagaacatatttggatgactataaggataaatttatcgaaaaatatggtgtagatcaagaagtacaaataacagaattatttgattctacatttggcataggagctccatataattataatcatcctcgaaatgacttttatgagtccgaaccgagtactctatactattcagaagaggagagagaaaagtacctcagcatgtatgtagaagccgttaaaaatcataatgtaattaatcttgacgacttagagtctcattatcaaaaaatggacttagaaaagaaaagtgaacttcaagggttagaattatttttgaatttggcaaaggagtatgaaaaagatatttttattttaggggatatcgttggaaataataatttgggaggggcatcaggtagattttctgcactctctccggagttaacaagttatcatagaacgatagtagattctgtcgaaagagaaaatgagaataaagaaattacatcgtgtgaaatagtatttcttccagaaaatatcagacatgctaacgttatgcatacatcaattatgaggaggaaagtacttccattttttacaagtacaagtcacaatgaagttctgttaactaatatctatattggaatagacgaaaaagaaaaattttatgcacgagacatttcaactcaagaggtattgaaattctacattacaagcatgtacaataaaacgttattcagtaatgagctaagatttctttacgaaatttcattagatgacaagtttggtaatttaccttgggaacttatttacagagactttgattatattccacgtttagtatttgacgaaatagtaatatctcctgctaaatggaaaatttggggaagggatgtaaatagtaagatgacaataagagaacttattcaaagcaaagaaattcccaaagagttttatattgtcaatggagataataaagtttatttatcacaggaaaacccattggatatggaaattttagagtcggcgataaagaagagctcaaaaagaaaagattttatagagctacaagaatattttgaagatgaaaatatcataaataaaggagaaaaggggagagttgccgatgttgtagtgccttttattagaacgagagcattaggtaatgaagggagagcatttataagagagaaaagagtttcggttgaacggcgtgaaaaattgccctttaacgagtggctttatctaaagttgtacatttctataaatcgtcaaaatgaatttttactgtcgtatcttccagatattcagaaaatagtagcaaacctgggtggaaatctattcttcctaagatatactgatcctaaaccacatattagattgcgtataaaatgttcagatttatttttagcttacggatctattcttgaaatcttaaaaaggagtcggaaaaataggataatgtcaacttttgatatttctatttatgatcaagaagtagaaagatatggtggatttgatactttagagttatccgaagcaatattttgtgccgattctaaaattattccaaatttgcttacattgataaaagatactaataatgattggaaagtcgatgatgtatcaatcttggtgaattatttatatctgaaatgcttctttcagaatgataacaaaaagattcttaattttttgaatttagttagtcctaaaaaggttaaagaaaatgtcaatgaaaagattgaacattatcttaagcttctgaaagttaataatctaggtgaccaaattttttatgacaagaattttaaagaattaaagcatgccataaaaaatttatttttaaaaatgatagctcaagattttgaacttcagaaagtttattcaattattgacagtatcattcatgtccataataaccgactaattggtattgaacgagataaagagaaattaatttattacacacttcaaaggttgtttgtttcggaagaatacatgaaatga

SEQ ID NO: 20 - protein, 57 aa, Lactococcus lactis
MSTKDFNLDLVSVSKKDSGASPRITSISLCTPGCKTGALMGCNMKTATCHCSIHVSK

SEQ ID NO: 21 - DNA, 318 bp, Lactococcus lactis
atgaatgatttattttatcatcggctaaaggaactagttgaatcaagtggtaaatctgcaaatcaaatagaaagggaattgggttaccctagaaattctttgaataattataagttgggaggagaaccctctgggacaagattaataggactatcagagtattttaatgtgtctccaaaatatctgatgggtataattgatgagcctaatgacagttctgcaattaatctttttaaaactctaactcaagaagagaaaaaagaaatgtttataatttgtcaaaaatggctttttttagaatatcaaatagagttataa

SEQ ID NO: 22 - DNA, 768 bp, Lactococcus lactis
atgatgaaaaaaggaatttttgtaattactatagtgatatctatagcattgataattggaggtttttatagttataattctaggataaataatctttcaaaagctgataaaggaaaagaagttgtaaaaaatagcagtgaaaaaaatcagatagaccttacctataaaaagtattataaaaatttaccaaaatcagttcaaaataaaatagatgatatttcatccaaaaataaagaagttactttaacttgtatttggcaatctgattcagttatttctgaacaatttcaacaaaacttacaaaaatattatggaaataagttttggaacatcaaaaatatcacttacaatggcgaaactagtgaacaattattggctgaaaaagttgaaaaccaagtattagccactaatcctgatgttgttttatatgaagctccactttttaatgataaccaaaacattgaagcaacagcctcactgactagtaatgagcaacttataacaaatttggctagtgcaggagcggaggtaatagttcaaccctctccaccgatttatggtggtgttgtgtaccccgtacaagaagaacagtttaaacaatctttatctacaaagtatccctatatagactactgggctagttacccagacaaaaattctgatgaaatgaaggggctgttttctgatgatggagtatatagaacattaaatgcttcggggaataaggtttggctagattatattactaaatattttacagcaaactaa

SEQ ID NO: 23 - DNA, 780 bp, Lactococcus lactis
atgcaggaaacacaggaacagacgattgatttaagagggatttttaaaattattcgcaaaaggttaggtttaatattatttagtgctttaatagtcacaatattagggagcatctacacattttttatagcctccccagtttacacagcctcaactcaacttgtcgttaaactaccaaattcggataattcagcagcctacgctggacaagtgaccgggaatattcaaatggcgaacacaattaaccaagttattgttagtccagtcattttagataaagttcaaagtaatttaaatctatctgatgactctttccaaaaacaagttacagcagcaaatcaaacaaattcacaagttattacgcttactgttaaatattctaatccttacattgcacaaaagattgcagacgagactgctaaaatatttagttcagacgcaccgaaactattgaatgttactaacgttaatattctatccaaagcaaaagctcaaacaacaccaattagtcctaaacctaaattgtatttagcgatatctgttatagtcggactagttttaggtttagccattgctttattgaaagaattgtttgataacaaaattaataaagaagaagatattgaagctctggggctcacggttcttggtgtaacaacctatgctcaaatgagtgattttaataagaatacaaataaaaatggcacgcaatcgggaactaagtcaagtccgcctagcgaccatgaagtaaatagatcatcaaaaaggaataaaagatag

SEQ ID NO: 24 - DNA, 696 bp, Lactococcus lactis
atggctaaaaataaaagaagcatagacaacaatcgttatattattaccagtgtcaatcctcaatcacctatttctgaacaatatcgtacgattcgtacgaccattgattttaaaatggcggatcaagggattaaaagttttctagtaacatcttcagaagcagctgcaggtaaatcaaccgcgagtgctaatatagctgttgcttttgcacaacaaggtaaaaaagtacttttaattgatggtgatcttcgtaaaccgactgttaacattacttttaaagtacaaaatagagtagggttaaccaatattttaatgcatcaatcttcgattgaagatgccatacaagggacaagactttctgaaaatcttacaataattacctctggtccaattccacctaatccatcggaattattagcatctagtgcaatgaagaatttgattgactctgtgtccgatttctttgatgttgttttgattgatactccacctctctctgcagttactgatgctcaaattttgagtagttatgtaggaggagtggttcttgttgtacgtgcctatgaaacaaaaaaagagagtttagcaaaaacaaaaaaaatgctggaacaagttaatgcaaatattttaggagttgttttgcatggggtagactcttctgactcaccgtcgtattactactacggagtagagtaa

SEQ ID NO: 25 - DNA, 687 bp, Lactococcus lactis
atggaattttttgaggatgcctcatcacctgaatcggaagagcctaagttagtagaattaaaaaatttttcttatagagagctaattataaaaagagcaattgatatcctaggaggattagcaggttcagttttatttcttattgcggctgcattgctttatgtgccttacaaaatgagctcaaaaaaagatcaagggccaatgttctataaacaaaaacggtatggaaaaaacggtaaaattttttatattttgaaatttagaacaatgattcttaatgccgagcagtatctagaacttaatccagatgttaaagctgcttaccatgccaacggcaataagctagaaaacgatccacgggtaacgaagattggctcatttataagacgacactcaattgatgaactgccacaatttatcaatgttcttaaaggggatatggcattggttggcccaagaccaattttgctttttgaagcgaaagaatatggggagcgcctctcttacttactcatgtgtaaacctggaattactggttattggacaacacatggtcgaagtaaagttctttttcctcaacgagcagatttagaactctattacctccagtaccatagtaccaaaaacgatatcaagcttctagtactcacaattgtacaaagtattaacggatcggacgcatattaa

SEQ ID NO: 26 - DNA, 765 bp, Lactococcus lactis
atgattgatattcattgccatattttaccgggtatagatgatggagctaaaacttctggagatactctgacaatgctgaaatcagcaattgatgaagggataacaactatcactgctactcctcatcataatcctcaatttaataatgaatcaccacttattttgaaaaaagttaaggaagttcaaaatatcattgacgaacatcaattaccaattgaagttttacccggacaagaggtgagaatatatggtgatttattaaaagaattttctgaaggaaagttactgacagcagcgggcacttcaagttatatattgattgaatttccatcaaatcatgtgccagcttatgctaaagaacttttttataatattcaattggagggacttcaacctattttggtccaccctgagcgtaatagcggaatcattgagaaccctgatatattatttgattttattgaacaaggagtactaagtcagataacagcttcaagtgtcactggtcattttggtaaaaaaatacaaaagctgtcatttaaaatgatagaaaaccatcttacgcattttgttgcatcagatgcgcataatgtgacgtcacgtgcatttaagatgaaggaagcgtttgaaattattgaagatagttatggttctgatgtatcacgaatgtttcaaaataatgcagagtcagtgattttaaacgaaagtttttatcaagaaaaaccaacaaagatcaaaacaaagaaatttttaggattattttaa

SEQ ID NO: 27 - DNA, 450 bp, Lactococcus lactis
atgaaaatagcattagtaggttccagcggtggccatttgacacacctgtatttgttaaaaaagttttgggaaaacgaagatagattttgggtcacatttgataaagcagatgcaaaatctatattgaaagaagaaagattttatccttgttattatcccacaaatagaaatgtaaaaaacacgataaaaaataccattcttgcatttaaaatacttagaaaagaaaaaccagatttgattatttcgagtggtgctgcggtagccgttccttttttttggttaggtaaactattcggtgcaaagacagtctatattgaaatatttgaccggatcgataaaccaaccttaacaggaaaattagtttatccagttactgataagtttatagttcaatgggaagagttaaaaaaagtttaccctaaagcaattaatttaggaggaattttctaa

SEQ ID NO: 28 - DNA, 507 bp, Lactococcus lactis
atgatttttgtaacggttggaactcacgaacaaccatttaatcgactcattcaaaaaattgatgaacttgtacgcgatggtgaaatcgaagacgatgtattcatgcaaattgggtactcaacttatgaacccaaatatactaaatgggaaaaggttattggatatgagactatggaaagatgtatgaatgaagcgagtacgattattactcatggcggaccatctacctatatgcaagtattacaactaggtaaaattccgatagttgttccacggcaaatgaaatttgatgagcatataaatgatcatcaaatttgggtaagtaaacaggttgtgaaaaagggatactcattgattttgtgcgaagatgttgaagacattctcgaaaatattattagctccaaaatttcagataccttacaaaaaaatgtaaatcacaacactgaattcataaaattattcagtgctgaaatttaccagctatttataaaaagtgagaagatatga

SEQ ID NO: 29 - DNA, 987 bp, Lactococcus lactis
atggttaaattttctataattattccagtatataacttagaagattatttatatcgctgtttagaatctgttctcaatcaagattataatgattttgagattatacttattaatgatggttcagatgataattcacttaatattatcgaagaatttaaaaatcaatattctagtaaaataaaagtaatttctcaagtgaatcaaggagtatcatcagcaagaaataagggacttcaagaagctgaaggggagtatataatttttatagatggggatgactacattgatagtaatcatttaagtaatattcttgaatatataggaaaatcaaaaaattcctttattctaaatagtctatttgtagagaccggggaaactacttgggttattcccaaagcaagtaagaattatgattgtagtttttatggaactcttatgaatattttagataatcatagatatcaaggctttttgtttaataaaatatttagtaattcagtaataaaaagtaatgaattgaagtttaaagaaaatttatattatgcggaagatacggagtttgttattcgataccttttggagttgcaaaagagagaatcggatttagttgctaatataattaattctccaacatatcattatgttcaaataaaaagtagtgctactcaccaatttaatatcagacaattttctctagtaaattctatggaggaaattcaatgtaatctagaaaaaatgaaatcaataaataaagaagttttgtatgtagtacaatcaaatttaattcagtcagtattgaaaatgataagattatctagaataaatggtgtagttaatgaacatttggaagattcattagataaaatcgtaacaaattcatgggataatattgaaactatctggaaatctcaaagaaagatttactctaaggtatttttaacactaagaattattcaggaaaaagttaagggtaagaaaatcaaatag

SEQ ID NO: 30 - DNA, 867 bp, Lactococcus lactis
gtgataattatacctatcttaatttttattacccttataggagcaggggcttatgccttaagagattcacttattcctactgaacatacgaaaacaaatagttcggatcaaccgaccaaaacttcggtttctaacggttacgtggagcaaaaaggtgaagaagctgctgtgggtagtatagcacttgtagatgacgctggagtaccagaatgggttaaagttccctcaaaggtaaatttagataaatttactgatttatctacgaataatatcactatttatcgaattaacaatccggaagtcttaaaaacagttaccgatcgtacggatcaacggatgaaaatgtcagaagttatagctaagtatcctaatactttgattatgaatgcttccgcttttgatatgcagacaggacaagtagctggatttcaaattaataatggaaagttgattcaagactggagtccaggtacaacgactcagtatgcttttgttattaacaaagatggttcgtgcaaaatttatgattcaagtacacctgcttcaactattattaaaaacggagggcaacaagcctatgattttggtactgcaattatccgtgatggtaaaattcaaccaagtgatggctcagtagattggaagatccatatttttattgcgaatgataaagataataatctctatgctattttgagtgatacaaatgcaggttatgataatataatgaaatcagtgtcaaatttgaagctccaaaatatgttattacttgatagtggtggttcaagtcaactatctgtcaatggtaaaacgattgttgctagtcaagatgatcgagccgtaccggattatattgtgatgaaataa

SEQ ID NO: 31 - DNA, 903 bp, Lactococcus lactis
atgaatcaaaaaaagaggcgtcattatcgtaagaaaaaatacacagtactaaaagttatttcaattatttttgtattagtaattatttctgttgcttctatagcctacgtagcttatagaaatgttgaatcaaccttttcaacatcatatgaaaatttccctaaaacaacaagtattgacttaaaaaaatctaaaacattcaccacacttatcattgcaactggtaaaaataattctaaaaattcagcttatgctactgttttagcttcaacgaatgtaaagacaaatcaaactactttcatgaacttcccagtttttgcgacactgcctaatcaaaaaacaatcactgaagtttacaatacgaatggagatgatggaattttccagatggttaaagacctattgaatgcgtccattaacaaagtaattcagatcgatgttaataaaatgggatcacttgtacaggccactggtggaatcaccatgcaaaatccaaaggcattcaatgctgaaggttatgagtttaaacaaggaactgttaatttacaaactgctgatcaagtccaagcctatatgacacaaattgacgatactgatttggatgcttcaatcactcggattcaaaatgtctcaatggaactctacgtaaatattaaaaaaattgctcatatgaaaaaacttgaaagtttcaattactatcgagaaattctctatgctttttcaaacactgttaaaaccaatataagtttcaatgatgctaaaacgatcgttatgagctacagtaaggctctaaagaataccagcaagctcaatctacatacaacagatgaaaatggagctaaggtcgtttctcaaacagaattagactcagtcaaaaccctttttgaaaaatctctaaaataa

SEQ ID NO: 32 - DNA, 1431 bp, Lactococcus lactis
ttgagtaacacaggaataaaagtaactaataaccaaatactaataagaaaagtaacagttatatttttgcttttttcaggaatttgggtaggagctgcaacaagtttttttgagatttctttagtgttttctgtattagctggtattataagctcaaatttactagaaaatgaatttgttccgtattcagttattttaatactggtttttcaaaatttattgataggtactgggtctcatttaacagggaatctgtcaggtttaacttatctcactcaagttccgatggtttttgtttggactattaatctctgtttgaaaaaggtagataaattatctaaagttgatatttcttttatagttcttatgatattttctttgtcatctttggcatttggacgagggccaattcaggcaattatttcgaacttaagagatttatcgacattttattttacttatcgtataggtaaaagatttatcaaaactgaagaaatatttgcgaggtttataaagaaaattctttatttaggaatatttgtagttttaattggtattatcttatacttaggaggctatcctctaaacaaatttttgggaatagatgaaatttactacgctaagggggtaactactttacttaataattttgatggcagatttggatcagatgtatttggaatttccgtaacacgtatgggatcaatttattttgaaccaataaatttggggtatttaatattttctatgctcattatatcctttattttctttaatacccaaaaattaaaatatataaatttatatagactgattttattgataggtggaatgttaacttttgggaaaggtgctatgcttctagctataggggtgatggttgcaggtatcggacataaattatttttaaaattcttttcaagaagtaatgaaatgaatgtttttagaaatctttttatattgttaactattattatgtttattggtggaaattattatttcaaaacttttggaggagctgtagggaatcacttttatgcaatccaagggacattggatagtataagtcatcgaccaattggttttggattaggtgtgggaggaaacgcctcagcagtatttacagggggagaacttgattttactactggatcagaaacagccttgttatcatttgtataccaaataggtgtacaaggtgctattgctttaatatgtgtattctactttatgagtaaagaagtgttggaaaaagtacagaagaattcacaattcaaaaatagatttttattttatgttccaatgatattgatttttgttagtatatatcaagctaatacatataccccacaatgtataacgttgttaatgattactttgggaggatttgtaggaatgagagacaggagaaggaaaaaatataatggttaa

SEQ ID NO: 33 - DNA, 702 bp, Lactococcus lactis
atgataccaaaagtaatacactattgctggttcggagggcaacctttaccagaatctgcgctaaaatgtattgaaagttggagaaggttttgtccagattatgaaataaaacaatggtctgagaaaaactatgatgtaaataaaattcaatatacaaaagaagcgtacgaaaagaaacgttatgcttttgtcacggatgttgcaaggcttgatatcatttatagtgaggggggcatttatcttgacactgatgttgaactgataaaacctttggatgatttgcttgtcaatcaagcatatatgggaatggaaactgctggtcgtgtaaataccggccaaggatttggagctataaaaaaccaccaaatagttaaagcaaatttagaggtttatgctgaacttgagtttgatggtacgactacttgtgtgacttacacaactaatttgttaaaaagatttggtttacaaaaaaaagatattaaccaggatttacaaggaataactatccttccgacagattatttatgtccattaagtcttgaaactaggaaattagtaattacagaaaatacattttctattcatcactatgatggtggttggaaaaaaggaaaagataaatttttatctctaaaaattaaaattcgacgctggattggtgataacttttatgagtcgataaaaacgaagttgaagggatag